(19) United States
(12) Patent Application Publication
(10) Pub. No.: US 2011/0124819 A1
(43) Pub. Date: May 26, 2011

(54) MODIFIED HALOGENATED POLYMER SURFACES

(75) Inventors: Werner Hoelzl, Eschentzwiller (FR); Holger Braun, Lorrach (DE); Olof Wallquist, Bottmingen (CH)

(73) Assignee: BASF SE, Ludwigshafen (DE)

(21) Appl. No.: 12/988,818

(22) PCT Filed: Apr. 22, 2009
(86) PCT No.: PCT/EP2009/054785

§ 371 Date: Jan. 24, 2011

(30) Foreign Application Priority Data
Apr. 25, 2008 (EP) 08155218.4

(51) Int. Cl. C08F 259/04; C08F 8/34; C08F 8/30

(52) U.S. Cl. 525/275; 525/350; 525/242; 525/282; 525/277; 525/291; 525/331.5; 525/276

(57) ABSTRACT

Disclosed is a method of preparing a modified halogenated polymer surface, comprising the steps of (a) activating the surface by modification with a polymerisation initiator by (a₁) reacting the halogenated polymer surface with sodium azide and subsequent (a₂) 1,3 dipolar cycloaddition with an alkine-functionalized initiator; or (a₃) reacting the halogenated polymer surface with mercapto-functionalized initiators; and (b) reacting the activated surface obtained in steps (a₁)/(a₂) or (a₃) with polymerizable monomeric units A and/or B. The modified halogenated polymer substrates according to the invention exhibit outstanding properties.

The present invention relates to a method of preparing modified halogenated polymer surfaces and the surface-modified halogenated polymer substrates prepared from halogenated polymers according to this method.

The surface properties of polymeric materials are important to many of their applications.

Due to the steadily growing importance of microtechniques in a wide variety of scientific applications, the development of systems which allow the interaction of molecules with surfaces remains a critical issue. Such interactions include the possibility of removing specific molecules from a sample, e.g. to facilitate their analysis/detection, but also of presenting molecules on a surface, thus allowing subsequent reactions to take place. These principles for the immobilization of molecules can be applied in sensor or chromatographic systems or for the provision of modified surfaces in general.

In recent years there have been numerous approaches to fabricate sensor chips which are based on self-assembled monolayers (SAM's) of bifunctional molecules which directly or indirectly couple sample molecules to the sensor surface. Typically, these bifunctional molecules carry a silane or thiol/disulfide moiety in order to achieve a bond with an inorganic surface and an additional functional group (e.g. amino or epoxide groups) which interact with sample molecules, often contained in biological samples in the form of an oligonucleotide, a protein or a polysaccharide etc.

A desired polymer surface can often not be obtained from the material itself but with modification.

Modifications of polymer surfaces can be obtained both by various physical and chemical processes.

It is well known prior art that PVC films can be modified and functionalized at the surface with small molecules such as thiolates or azide via nucleophilic substitution of chlorine atoms by wet-chemical treatments using mixtures of solvents and non-solvents for the polymer or by using a phase transfer catalyst like nBu₄NBr in aqueous solutions (J. Sacristán, C. Mijangos, H. Reinecke, Polymer 2000, 41 5577-5582; A. Jayakrishnan, M. C. Sunny, Polymer 1996, 37, 5213-5218).

Methods of modifying plasticized PVC films by wet-chemical modification methods are disclosed in J. Sacristán, C. Mijangos, H. Reinecke, Polymer 2000, 41, 5577-5582; J. Reyes-Labarta, M. Herrero, P. Tiemblo, C. Mijangos, H. Reinecke, Polymer 2003, 44, 2263-2269; M. Herrero, R. Navarro, N. Garcia, C. Mijangos, H. Reinecke, Langmuir, 2005, 21, 4425-4430.

The described modified PVC films do not encompass PVC films having an oligomeric or polymeric unit bond to the PVC film.

Living polymerization systems have been developed which allow for the control of molecular weight, end group functionality, and architecture.[Webster, O. Science, 1991, 251 887].

Most notably, these systems involve ionic polymerization. As these polymerization systems are ionic in nature, the reaction conditions required to successfully carry out the polymerization include the complete exclusion of water from the reaction medium. Another problem with ionic living polymerizations is that one is restricted in the number of monomers which can be successfully polymerized. Also, due to the high chemoselectivity of the propagating ionic centers, it is very difficult, if not impossible, to obtain random copolymers of two or more monomers; block copolymers are generally formed.

Radical polymerization is one of the most widely used methods for preparing high polymer from a wide range of vinyl monomers. Although radical polymerization of vinyl monomers is very effective, it does not allow for the direct control of molecular weight (DPₙ≠Δ[Monomer]/[Initiator]ₒ), control of chain end functionalities or for the control of the chain architecture, e.g., linear vs. branched or graft polymers. In the past five years, much interest has been focused on developing a polymerization system which is radical in nature but at the same time allows for the high degree of control found in the ionic living systems.

A polymerization system has been previously disclosed that does provide for the control of molecular weight, end groups, and chain architecture, and that was radical in nature, (K. Matyjaszewski, J. -S. Wang, Macromolecules 1995, 28, 7901-7910; K. Matyjaszewski, T. Patten, J. Xia, T. Abernathy, Science 1996, 272, 866-868; U.S. Pat. No. 5,763,548; U.S. Pat. No. 5,807,937; U.S. Pat. No. 5,789,487) the contents of which are hereby incorporated by reference. This process has been termed atom transfer radical polymerization (ATRP). ATRP employs the reversible activation and deactivation of a compound containing a radically transferable atom or group to form a propagating radical (R•) by a redox reaction between the radical and a transition metal complex (Mₜⁿ⁻¹) with a radically transferable group (X).

Controlled polymerization is initiated by use, or formation, of a molecule containing a radically transferable atom or group. Previous work has concentrated on the use of an alkyl halide adjacent to a group which can stabilize the formed radical. Other initiators may contain inorganic/pseudo halogen groups which can also participate in atom transfer, such as nitrogen, oxygen, phosphorous, sulfur, tin, etc.

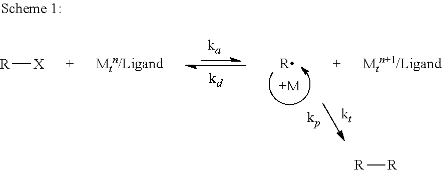

The most important aspect of the reaction outlined in Scheme 1 is the establishment of an equilibrium between the active radicals and the dormant species, R—X (dormant polymer chains=Pₙ-X). Understanding and controlling the balance of this equilibrium is very important in controlling the radical polymerization. If the equilibrium is shifted too far towards the dormant species, then there would be no polymerization. However, if the equilibrium is shifted too far towards the active radical, too many radicals are formed resulting in undesirable bimolecular termination between radicals. This would result in a polymerization that is not controlled. An example of this type of irreversible redox initiation is the use of peroxides in the presence of iron (II). By obtaining an equilibrium which maintains a low, but nearly constant concentration of radicals, bimolecular termination between growing radicals can be suppressed, one obtains high polymer.

Surprisingly it has been found that modified halogenated polymer surfaces can be obtained by covalent binding of a radical initiator on the surface of the halogenated polymer and subsequent grafting polymers of defined composition on this modified halogenated polymer surface in a controlled polymerization reaction.

The halogenated polymer surface modified in this manner exhibits new properties.

Therefore, the present invention relates to a method of preparing a modified halogenated polymer surface, comprising the steps of

(a) activating the surface by modification with a polymerisation initiator by
(a₁) reacting the halogenated polymer surface with sodium azide and subsequent
(a₂) 1,3 dipolar cycloaddition with an alkine-functionalized initiator; or alternatively
(a₃) reacting the halogenated polymer surface with mercapto-functionalized initiators; and

(b) reacting this activated surface obtained in steps (a₁)/(a₂) or (a₃) with polymerizable monomeric units A and/or B.

In the first reaction step (a₁) the halogenated polymer substrate is treated with sodium azide in a manner known per se as for example disclosed by A. Jayakrishnan, M. C. Sunny, Polymer 1996, 37, 5213-5218.

In this reaction step the azide group will be covalently bonded on the surface of the halogenated polymer.

This reaction is preferably carried out in a 1% to 25% aqueous solution of sodium azide at a temperature from 20° C. to 100° C., preferably from 60° C. to 90° C.

The reaction time is from 0.1 h to 2 h, preferably 1 h to 4 h.

The reaction is preferably carried out in the presence of a phase transfer catalyst, more preferably in the presence of n-tetrabutyl ammonium bromide.

The activation of the surface can be controlled by IR spectroscopy due to the strong IR activity of the azide.

The degree of modification of the halogenated polymer substrate depends on reaction parameters like reaction time, temperature, solvents and the concentration of the reagents.

The reaction (a₁) comprises the steps of interaction of the surface of the polymer substrate with the reaction medium (a₁ₐ), which contemplates the diffusion of the solvent into the upper part of the surface, the second step is the transport of the modification agent to the functional group of the polymer (a_{1b}), and the third step is the reaction itself (a_{1c}).

The reaction step (a₁) can be illustrated by the following reaction scheme:

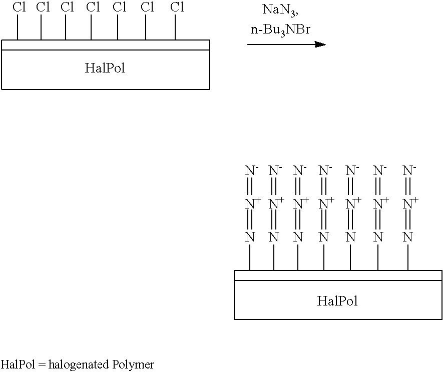

Reaction step (a₂) represents a copper-catalyzed 1,3 dipolar cycloaddition with an alkine-functionalized initiator. This reaction is known as Huisgen- or click-reaction.

The reaction step (a₂) can be illustrated by the following reaction scheme:

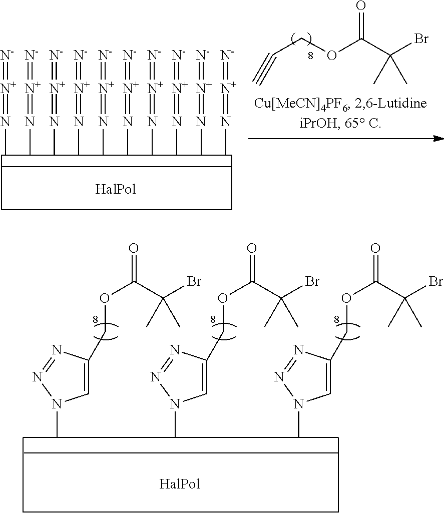

In this reaction step a suitable initiator is bonded to the halogenated polymer substrate.

This reaction is preferably carried out in a 0.1% to 10% solution of the respective alkine in iso-propanol at a temperature from 20° C. to 100° C., preferably at 50° C. to 80° C.

The reaction time is from 0.1 h to 24 h, preferably 10 h to 16 h.

The reaction is preferably carried out in the presence of a copper catalyst and a base, more preferably in the presence of Cu[MeCN]₄PF₆ and 2,6-lutidine.

The reaction can be controlled by IR spectroscopy due to the strong IR activity of the carbonyl-moiety.

Examples of halogenated polymers include

Halopolymers include organic polymers which contain halogenated groups, such as chloropolymers, fluoropolymers and fluorochloropolymers. Examples of halopolymers include fluoroalkyl, difluoroalkyl, trifluoroalkyl, fluoroaryl, difluoroaryl, trifluoroaryl, perfluoroalkyl, perfluoroaryl, chloroalkyl, dichloroalkyl, trichloroalkyl, chloroaryl, dichloroaryl, trichloroaryl, perchloroalkyl, perchloroaryl, chlorofluoroalkyl, chlorofluoroaryl, chlorodifluoroalkyl, and dichlorofluoroalkyl groups. Halopolymers also include fluorohydrocarbon polymers, such as polyvinylidine fluoride (“PVDF”), polyvinylflouride (“PVF”), polychlorotetrafluoroethylene (“PCTFE”), polytetrafluoroethylene (“PTFE”) (including expanded PTFE (“ePTFE”)). Other halopolymers include fluoropolymers perfluorinated resins, such as perfluorinated siloxanes, perfluorinated styrenes, perfluorinated urethanes, and copolymers containing tetrafluoroethylene and other perfluorinated oxygen-containing polymers like perfluoro-2,2-dimethyl-1,3-dioxide (which is sold under the trade name TEFLON-AF). Still other halopolymers which can be used in the practice of the present invention include perfluoroalkoxy-substituted fluoropolymers, such as MFA (available from Ausimont USA (Thoroughfare, N.J.)) or PFA (available from Dupont (Willmington, Del.)), polytetrafluoroethylene-co-hexafluoropropylene (“FEP'”), ethylenechlorotrifluoroethylene copolymer (“ECTFE”), and polyester based polymers, examples of which include polyethyleneterphthalates, polycarbonates, and analogs and copolymers thereof.

Halogen-containing polymers comprise polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

The term “polyvinyl chloride” means compositions whose polymer is a vinyl chloride homopolymer. The homopolymer may be chemically modified, for example by chlorination.

They are in particular polymers obtained by copolymerization of vinyl chloride with monomers containing an ethylenically polymerizable bond, for instance vinyl acetate, vinylidene chloride; maleic or fumaric acid or esters thereof; olefins such as ethylene, propylene or hexene; acrylic or methacrylic esters; styrene; vinyl ethers such as vinyl dodecyl ether.

The compositions according to the invention may also contain mixtures based on chlorinated polymers containing minor quantities of other polymers, such as halogenated polyolefins or acrylonitrile/butadiene/styrene copolymers.

Usually, the copolymers contain at least 50% by weight of vinyl chloride units and preferably at least 80% by weight of such units.

In general, any type of polyvinyl chloride is suitable, irrespective of its method of preparation. Thus, the polymers obtained, for example, by performing bulk, suspension or emulsion processes may be stabilised using the composition according to the invention, irrespective of the intrinsic viscosity of the polymer.

Preferably, the initiator represents the fragment of a polymerization initiator capable of initiating polymerization of ethylenically unsaturated monomers in the presence of a catalyst which activates controlled radical polymerization.

The initiator is preferably selected from the group consisting of C₁-C₈-alkylhalides, C₆-C₁₅-aralkylhalides, C₂-C₈-haloalkyl esters, arene sulphonyl chlorides, haloalkanenitriles, α-haloacrylates and halolactones.

Specific initiators are selected from the group consisting of α,α′-dichloro- or α,α′-dibromoxylene, p-toluenesulfonylchloride (PTS), hexakis-(α-chloro- or α-bromomethyl)-benzene, 1-phenethyl chloride or bromide, methyl or ethyl 2-chloro- or 2-bromopropionate, methyl or ethyl-2-bromo- or 2-chlorooisobutyrate, and the corresponding 2-chloro- or 2-bromopropionic acid, 2-chloro- or 2-bromoisobutyric acid, chloro- or bromoacetonitrile, 2-chloro- or 2-bromo-propionitrile, α-bromo-benzacetonitrile, α-bromo-γ-butyrolactone (=2-bromo-dihydro-2(3H)-furanone) and the initiators derived from 1,1,1-(tris-hydroxymethyl)propane and pentaerythritol of the formulae of above.

ATRP Initiators

Initiators for ATRP can be prepared by a variety of methods. Since all that is needed for an ATRP initiator is a radically transferable atom or group, such as a halogen, standard organic synthetic techniques can be applied to preparing ATRP initiators. Some general methods for preparing ATRP initiators will be described here. In general the initiators can have the general formula: Y—(X)ₙ. wherein Y is the core of the molecule and X is the radically transferable atom or group. The number n can be any number 1 or higher, depending on the functionality of the core group Y. For example, when Y is benzyl and X is bromine, with n=1, the resulting compound is benzyl bromide. If Y is a phenyl moeity having a CH₂ group attached to each carbon of the phenyl ring and X is Br with n=6, the compound is hexa(bromomethyl)benzene, a hexafunctional initiator useful for the preparation of six polymer chains from a single initiator.

As a first division of the initiator types, there are two classes, small molecule and macro-molecule. The small molecule initiators can be commercially available, such as benzylic halides, 2-halopropionates and 2-haloisobutyrates, 2-halopropionitriles, α-halomalonates, tosyl halides, carbon tetrahalides, carbon trihalides, etc. Of course, these functional groups can be incorporated into other small molecules. The incorporation of these functional groups can be done as a single substitution, or the small molecule can have more than one initiating site for ATRP. For example, a molecule containing more than one hydroxyl group can undergo an esterification reaction to generate α-haloesters which can initiate ATRP. Of course, other initiator residues can be introduced as are desired. The small molecules to which the initiators are attached can be organic or inorganic based; so long as the initiator does not poison the catalyst or adversely interact with the propagating radical it can be used. Some examples of small molecules that were used as a foundation for the attachment of initiating sites are polydimethylsiloxane cubes, cyclotriphosphazene rings, 2-tris(hydroxyethyl)ethane, glucose based compounds, etc. Additionally, trichloromethyl isocyanate can be used to attach an initiator residue to any substance containing hydroxy, thiol, amine and/or amide groups.

Macroinitiators can take many different forms, and can be prepared by different methods. The macroinitiators can be soluble polymers, insoluble/crosslinked polymeric supports, surfaces, or solid inorganic supports. Some general methods for the preparation of the macroinitiators include modification of an existing material, (co)polymerization of an AB* monomer by ATRP/non-ATRP methods, or using initiators (for other types of polymerization) that contain an ATRP initiator residue. Again, modification of macromolecular compounds/substrates to generate an ATRP initiation site is straightforward to one skilled in the art of materials/polymer modification. For example, crosslinked polystyrene with halomethyl groups on the phenyl rings (used in solid-phase peptide synthesis), attached functional molecules to silica surfaces, brominated soluble polymers (such as (co)polymers of isoprene, styrene, and other monomers), or attached small molecules containing ATRP initiators to polymer chains can all be used as macromolecular initiators. If one or more initiating sites are at the polymer chain ends, then block (co)polymers are prepared; if the initiating sites are dispersed along the polymer chain, graft (co)polymers will be formed.

AB* monomers, or any type of monomer that contains an ATRP initiator residue, can be (co)polymerized, with or without other monomers, by virtually any polymerization process, except for ATRP to prepare linear polymers with pendant B* groups. The only requirement is that the ATRP initiator residue remains intact during and after the polymerization. This polymer can then be used to initiate ATRP when in the presence of a suitable vinyl monomer and ATRP catalyst. When ATRP is used to (co)polymerize the AB* monomers, (hyper)branched polymers will result. Of course, the macromolecules can also be used to initiate ATRP.

Functionalized initiators for other types of polymerization systems, i.e., conventional free radical, cationic ring opening, etc., can also be used. Again, the polymerization mechanism should not involve reaction with the ATRP initiating site. Also, in order to obtain pure block copolymers, each chain of the macroinitiator must be initiated by the original functionalized initiator. Some examples of these type of initiators would include functionalized azo compounds and peroxides (radical polymerization), functionalized transfer agents (cationic, anionic, radical polymerization), and 2-bromopropionyl bromide/silver triflate for the cationic ring opening polymerization of tetrahydrofuran.

The ATRP initiators can be designed to perform a specific function after being used to initiate ATRP reactions. For example, biodegradable (macro)initiators can be used as a method to recycle or degrade copolymers into reusable polymer segments. An example of this would be to use a difunctional biodegradable initiator to prepare a telechelic polymer. Since telechelic polymers can be used in step-growth polymerizations, assuming properly functionalized, linear polymers can be prepared with multiple biodegradable sites along the polymer chains. Under appropriate conditions, i.e., humidity, enzymes, etc., the biodegradable segments can break down, and the vinyl polymer segments recovered and recycled. Additionally, siloxane containing initiators can be used to prepare polymer with siloxane end groups/blocks. These polymers can be used in sol-gel processes.

It is also possible to use multifunctional initiators having one or more initiation sites for ATRP and one or more initiation sites capable of initiating a non-ATRP polymerization. The non-ATRP polymerization can include any polymerization mechanism, including, but not limited to, cationic, anionic, free radical, metathesis, ring opening and coordination polymerizations. Exemplary multifunctional initiators include, but are not limited to, 2-bromopropionyl bromide (for cationic or ring opening polymerizations and ATRP); halogenated AIBN derivatives or halogenated peroxide derivatives (for free radical and ATRP polymerizations); and 2-hydroxyethyl 2-bromopropionate (for anionic and ATRP polymerizations).

Reverse ATRP is the generation, in situ, of the initiator containing a radically transferable group and a lower oxidation state transition metal, by use of a conventional radical initiator and a transition metal in a higher oxidation state associated with a radically transferable ligand (X), e.g., Cu (II) Br₂, using the copper halide as a model. When the conventional free radical initiator decomposes, the radical formed may either begin to propagate or may react directly with the Mⁿ⁻¹X_{y}L (as can the propagating chain) to form an alkyl halide and MⁿX_{y-1}L. After most of the initiator/Mⁿ⁻¹X_{y}L is consumed, predominately the alkyl halide and the lower oxidation metal species are present; these two can then begin ATRP.

Previously, Cu(II)X₂/bpy and AIBN have been used as a reverse ATRP catalyst system. (U.S. Pat. No. 5,763,548, K, Matyjaszewski, J. -S. Wang, Macromolecules 1995, 28, 7572-7573) However, molecular weights were difficult to control and polydispersities were high. Also, the ratio of Cu(II) to AIBN was high, 20:1. The present invention provides an improved reverse ATRP process using dNbpy, to solubilize the catalyst, which leads to a significant improvement in the control of the polymerization and reduction in the amount of Cu(II) required.

Reverse ATRP can now be successfully used for the “living” polymerization of monomers such as styrene, methyl acrylate, methyl methacrylate, and acrylonitrile. The polymer molecular weights obtained agree with theory and polydispersities are quite low, M_{w}/Mₙ.=1.2. Due to the enhanced solubility of the Cu(II) by using dNbpy, as the ligand, the ratio of Cu(II):AIBN can be drastically reduced to a ratio of 1:1. Unlike standard AIBN initiated polymerizations, the reverse ATRP initiated polymers all have identical 2-cyanopropyl (from decomposition of AIBN) head groups and halogen tail groups which can further be converted into other functional groups. Additionally, substituents on the free radical initiator can be used to introduce additional functionality into the molecule.

The radical initiator used in reverse ATRP can be any conventional radical initiator, including but not limited to, organic peroxides, organic persulfates, inorganic persulfates, peroxydisulfate, azo compounds, peroxycarbonates, perborates, percarbonates, perchlorates, peracids, hydrogen peroxide and mixtures thereof. These initiators can also optionally contain other functional groups that do not interfere with ATRP.

Alternatively, the activation of the halogenated polymer surface by modification with a polymerisation initiator can be carried out by a thiol-substituted initiator (reaction step (a₃)). In this case the sulphur reacts as a nucleophile and the corresponding initiator can be bonded at the halogenated polymer surface by substitution of the chloro atom.

The reaction step (a₃) can be illustrated by the following reaction scheme:

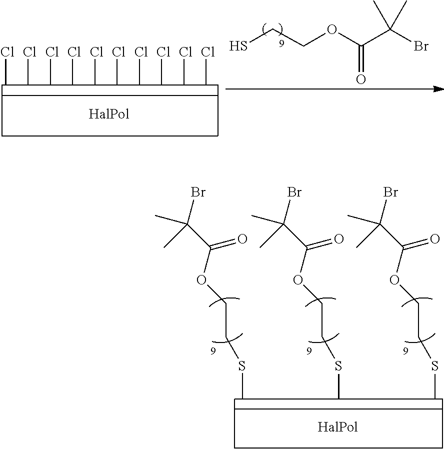

In the reaction step (b) the polymerizable monomeric units A and B are preferably copolymerized by atom transfer radical polymerization (ATRP) participating the initiator of the activated surface obtained in steps (a₁)/(a₂) or (a₃).

The ATRP method enables the production of so called “polymer brushes” on the modified halogenated polymer surface, i.e. covalently bound polymer chains of defined composition with low polydispersity and exclusion from cross linking. It is to be noted, that the polymer brushes formed in the invention may also be formed by several other polymerization methods, which are standart in the art, including but not limited to RAFT, NMP and ROMP.

In principal it is possible to carry out the polymerization with the monomeric unit A following the reaction with the monomeric unit B.

It is also possible to carry out the polymerization reaction with a mixture of the monomeric units A and B.

The halogenated polymer substrate, for example in form of a film, which was modified according to reaction steps (a₁), (a₂) or (a₃) is reacted in a further reaction step (b) with the corresponding monomer under suitable conditions.

The reaction step (b) can be illustrated by the following reaction scheme:

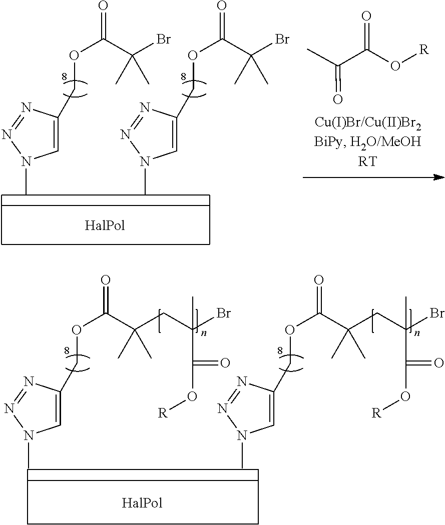

This reaction is preferably carried out in a 5% to 50% solution of the respective monomer in a mixture of water and an alcohol or in an alcohol at a temperature from 20° C. to 100° C., preferably at 20° C. to 60° C.

The reaction time is from 0.1 h to 24 h, preferably 1 h to 4 h.

The reaction is preferably carried out in the presence of a catalyst system, more preferably in the presence of CuBr, Cubr₂ and Bipyridin.

Monomers

The monomers useful in the present polymerization processes can be any radically (co)polymerizable monomers. Within the context of the present invention, the phrase “radically (co)polymerizable monomer” indicates that the monomer can be either homopolymerized by radical polymerization or can be radically copolymerized with another monomer, even though the monomer in question cannot itself be radically homopolymerized. Such monomers typically include any ethylenically unsaturated monomer, including but not limited to, styrenes, acrylates, methacrylates, acrylamides, acrylonitriles, isobutylene, dienes, vinyl acetate, N-cyclohexyl maleimide, 2-hydroxyethyl acrylates, 2-hydroxyethyl methacrylates, and fluoro-containing vinyl monomers. These monomers can optionally be substituted by any substituent that does not interfere with the polymerization process, such as alkyl, alkoxy, aryl, heteroaryl, benzyl, vinyl, allyl, hydroxy, epoxy, amide, ethers, esters, ketones, maleimides, succinimides, sulfoxides, glycidyl or silyl.

The polymers may be prepared from a variety of monomers. A particularly useful class of water-soluble or water-dispersible monomers features acrylamide monomers having the formula:

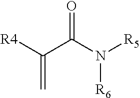

where R₄ is H or an alkyl group; and R₅ and R₆, independently, are selected from the group consisting of hydrogen, alkyl, substituted alkyl, cycloalkyl, substituted cycloalkyl, heteroalkyl, heterocycloalkyl, substituted heterocycloalkyl, aryl, substituted aryl, heteroaryl, substituted heteroaryl, alkoxy, aryloxy, and combinations thereof; R₅ and R₆ may be joined together in a cyclic ring structure, including heterocyclic ring structure, and that may have fused with it another saturated or aromatic ring. An especially preferred embodiment is where R₅ and R₆, independently, are selected from the group consisting of hydroxy-substituted alkyl, polyhydroxy-substituted alkyl, amino-substituted alkyl, polyamino-substituted alkyl and isothiocyanato-substituted alkyl. In preferred embodiments, the polymers include the acrylamide-based repeat units derived from monomers such as acrylamide, methacrylamides, N-alkylacrylamide (e.g., N-methylacrylamide, N-tert-butylacrylamide, and N-n-butylacrylamide), N-alkylmethacrylamide (e.g., N-tert-butylmethacrylamide and N-n-butylmethacrylamide), N,N-dialkylacrylamide (e.g., N,N-dimethylacrylamide), N-methyl-N-(2-hydroxyethyl)acrylamide, N,N-di-alkylmethacrylamide, N-methylolmethacrylamide, N-ethylolmethacrylamide, N-methylolacrylamide, N-ethylolacrylamide, and combinations thereof. In another preferred embodiment, the polymers include acrylamidic repeat units derived from monomers selected from N-alkylacrylamide, N-alkylmethacrylamide, N,N-dialkylacrylamide and N,N-dialkylmethacrylamide. Preferred repeat units can be derived, specifically, from acrylamide, methacrylamide, N,N-dimethylacrylamide, and tert-butylacrylamide.

Copolymers can include two or more of the aforementioned acrylamide-based repeat units. Copolymers can also include, for example, one or more of the aforementioned polyacrylamide-based repeat units in combination with one or more other repeat units.

Generally speaking, in some embodiments of the present invention the monomer may be represented by the formula

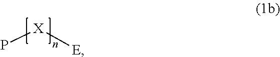

wherein

P is a functional group that polymerizes in the presence of free radicals (e.g., a carbon-carbon double bond), and E is a group that can react with the probe of interest and form a chemical bond therewith.

The bond which forms between E, or a portion thereof, and the probe in most cases is covelent, or has a covalent character. It is to be noted, however, that the present invention also encompasses other type of bonds or bonding (e.g., hydrogen bonding, ionic bonding, metal coordination, or combinations thereof). One example of the latter is when the E group contains a metal complexing agent that can bind a protein through a mixed complex: E can be, for instance, a ligand, such as iminodiacetic acid that can bind histidine tagged proteins through Ni mixed complexes.

E can be for example, but is not limited to, isothiocyanates, isocyanates, acylacydes, aldehydes, amines, sulfonylchlorides, epoxides, carbonates, acidfluorides, acidchlorides, acidbromides, acidanhydrides, acylimidazoles, thiols, alkyl halides, maleimides, aziridines and oxiranes.

In another embodiment, E is a phenylboronic acid moiety, which can strongly complex to biological probes that contains certain polyol molecules (e.g., 1,2-cis diols or other related compounds). In one preferred embodiment, E is an electrophilic group that, upon reaction with a nucleophilic site present in the probe, forms a chemical bond with the probe. Such activated monomers include, but are not limited to, N-hydroxysuccinimides, tosylates, brosylates, nosylates, mesylates, etc. In other embodiments, the electrophilic group consists of a 3- to 5-membered ring which opens upon reaction with the nucleophile. Such cyclic electrophiles include, but are not limited to, epoxides, oxetanes, aziridines, azetidines, episulfides, 2-oxazolin-5-ones, etc. In still other embodiments, the electrophilic group may be a group wherein, upon reaction with the nucleophilic probe, an addition reaction takes place, leading to the formation of a covalent bond between the probe and the polymer. These electrophilic groups include, but are not limited to, maleimide derivatives, acetylacetoxy derivatives, etc.

With respect to X, it is to be noted that, when present (i.e., when n is not equal to zero), X represents some linking group which connects P to E, such as in the case of X linking an unsaturated carbon atom of P to an electrophilic E group. X may be, for example, a substituted or unsubstituted hydrocarbylene or heterohydrocarbylene linker, a hetero linker, etc., including linkers derived from alkyl, amino, aminoalkyl or aminoalkylamido groups. In such instances, m is an integer such as 1, 2, 3, 4 or more. In other embodiments (i.e., when n is equal to zero), P is directly bound to E.

X is for example chosen from a covalent bond, an optionally substituted C₁-C₄O alkyl radical optionally interrupted by a (hetero)cycle, the alkyl radical being optionally interrupted by at lest one heteroatom or group comprising at least one heteroatom or an optionally substituted phenyl radical.

In one preferred embodiment, X is a linker generally represented by the formula

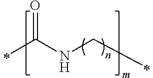

wherein n is an integer from about 1 to about 5, and m is an integer from about 1 to about 2, 3, 4 or more. In one such embodiment, preferred monomers include those having an N-hydroxysuccinimide group. For example, certain of such monomers may generally be represented by the following formula

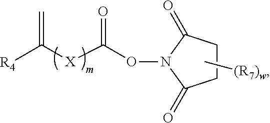

wherein
R₄ is a hydrogen or an akyl substitutent, and
R₇ is one or more substituents (i.e., w is 1, 2) selected from the group consisting of hydrogen substituted or unsubstituted hydrocarbyl (e.g., alkyl, aryl, heteroalkyl), heterohydrocarbyl, alkoxy, substituted or unsubstituted aryl, sulphates, thioethers, ethers, hydroxy, etc.

Generally speaking, R₇ can essentially be any substituent that does not substantially decrease the hydrophilic of the water-soluble or water-dispersible segment in which it is contained. In this regard it is to be noted that a number of substituted succinimide compounds are commercially available and are suitable for use in the present invention.

Among the particularly preferred monomers is included N-acryloxysuccinimide and 2-(methacryloyloxy)ethylamino N-succinimidvl carbamate. which are generally represented by compounds of the formula (I)

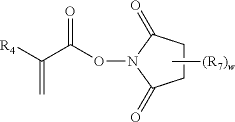

and formula (II)

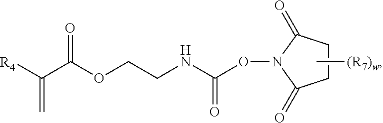

wherein

R₄, R₇ and w are as previously defined.

Also preferred are those monomers represented by formulas (III) and (IV) below, wherein the terminal carbonyl-oxo-succinimide group is positioned further from the polymer chain backbone by the presence of an aminoalkyl or aminoalkylamido linker (i.e., “X”), respectively the compounds of formula (III)

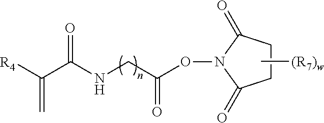

and

(IV)

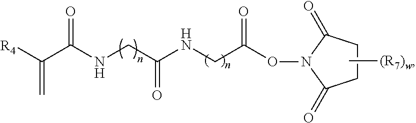

wherein

R₄, R₇, n and w are as previously defined.

Alternatively, however, monomers such as 2-(methylacryloyloxy)ethyl acetoacetate, glycidyl methacrylate (GMA) and 4,4-dimethyl-2-vinyl-2-oxazolin-5-one, generally represented by formulas

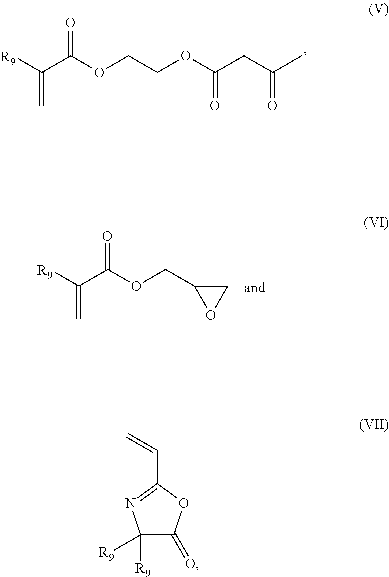

respectively, may also be employed. R₉ is hydrogen or hydrocarbyl, such as methyl, ethyl, propyl, etc., as defined herein).

One or more of the above referenced monomers (e.g., N-acryloxysuccinimide, 2-(methylacryloyloxy)ethyl acetoacetate, glycidyl methacrylate and 4,4-dimethyl-2-vinyl-2-oxazolin-5-one) are commercially available, for example from Aldrich Chemical Company. Additionally, monomers generally represented by formulas (III) and (IV), above, may be prepared by means common in the art.

It is to be noted that such monomers may advantageously be employed in any of the polymerization processes described herein, including nitroxide and iniferter initiated systems.

Suitable polymerization monomers and comonomers of the present invention include, but are not limited to, methyl methacrylate, ethyl acrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, acrylates and styrenes selected from glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoacrylate, triethyleneglycol acrylate, methacrylamide, N-methylacrylamide, N,N-dimethylacrylamide, N-tert-butylmethacrylamide, N-n-butylmethacrylamide, N-methylolacrylamide, N-ethylolacrylamide, vinyl benzoic acid (all isomers), diethylaminostyrene (all isomers), alpha-methylvinyl benzoic acid (all isomers), diethylamino alpha-methylstyrene (all isomers), p-vinylbenzenesulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropyoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl flouride, vinyl bromide, maleic anhydride, N-phenyl maleimide, N-butylmaleimide, N-vinylpyrrolidone, N-vinylcarbazole, betaines, sulfobetaines, carboxybetaines, phosphobetaines, butadiene, isoprene, chloroprene, ethylene, propylene, 1,5-hexadienes, 1,4-hexadienes, 1,3-butadienes, and 1,4-pentadienes.

Additional suitable polymerizable monomers and comonomers include, but are not limited to, vinyl acetate, vinyl alcohol, vinylamine, N-alkylvinylamine, allylamine, N-alkylallylamine, diallylamine, N-alkyldiallylamine, alkylenimine, acrylic acids, alkylacrylates, acrylamides, methacrlic acids, maleic anhydride, alkylmethacrylates, n-vinyl formamide, vinyl ethers, vinyl naphthalene, vinyl pyridine, vinyl sulfonates, ethylvinylbenzene, aminostyrene, vinylbiphenyl, vinylanisole, vinylimidazolyl, vinylpyridinyl, dimethylaminomethystyrene, trimethylammonium ethyl methacrylate, trimethylammonium ethyl acrylate, dimethylamino propylacrylamide, trimethylammonium ethylacrylate, trimethylammonium ethyl methacrylate, trimethylammonium propyl acrylamide, dodecyl acrylate, octadecyl acrylate, and octadecyl methacrylate.

“Betaine”, as used herein, refers to a general class of salt compounds, especially zwitterionic compounds, and include polybetaines. Representative examples of betaines which can be used with the present invention include: N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)-dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl)imidazolium hydroxide, (2-acryloxyethyl)carboxymethyl methylsulfonium chloride, 1-(3-sulfopropyl)-2-vinylpyridinium betaine, N-(4-sulfobutyl)-N-methyl-N,N-diallylamine ammonium betaine (MDABS), N,N-diallyl-N-methyl-N-(2-sulfoethyl)ammonium betaine, and the like.

It is to be understood, that the above described functional monomers, especially monomers containing basic amino groups, can also be used in form of their corresponding salts. For example acrylates, methacrylates or styrenes containing amino groups can be used as salts with organic or inorganic acids or by way of quaternisation with known alkylation agents like benzyl chloride. The salt formation can also be done as a subsequent reaction on the preformed block copolymer with appropriate reagents. In another embodiment, the salt formation is carried out in situ in compositions or formulations, for example by reacting a block copolymer with basic or acidic groups with appropriate neutralisation agents during the preparation of a pigment concentrate.

The grafted polymers formed on the surface of the halogenated polymer substrate form thin layers of 5 nm to 100 μm, preferably 10 nm to 200 nm and distinguish by a low polydisperisty which is <3.

The layer thickness of the polymers formed on the surface is dependent on the parameters like solvents, concentration of reactands, temperature and/or reaction time.

If necessary, these polymers may be present in form of polymer brushes, i.e. in form of chains which are oriented perpendicular to the surface.

“Polymer brushes,” as the name suggests, contain polymer chains, one end of which is directly or indirectly tethered to a surface and another end of which is free to extend from the surface, somewhat analogous to the bristles of a brush.

Covalent attachment of polymers to form polymer brushes is commonly achieved by “grafting to” and “grafting from” techniques. “Grafting to” techniques involve tethering pre-formed end-functionalized polymer chains to a suitable substrate under appropriate conditions. “Grafting from” techniques, on the other hand, involve covalently immobilizing initiators on the substrate surface, followed by surface initiated polymerization to generate the polymer brushes.

Each of these techniques involves the attachment of a species (e.g., a polymer or an initiator) to a surface, which may be carried out using a number of techniques that are known in the art.

As noted above, in the “grafting from” process once an initiator is attached to the surface, a polymerization reaction is then conducted to create a surface bound polymer. Various polymerization reactions may be employed, including various condensations, anionic, cationic and radical polymerization methods. These and other methods may be used to polymerize a host of monomers and monomer combinations.

Specific examples of radical polymerization processes are controlled/“living” radical polymerizations such as metal-catalyzed atom transfer radical polymerization (ATRP), stable free-radical polymerization (SFRP), nitroxide-mediated processes (NMP), and degenerative transfer (e.g., reversible addition-fragmentation chain transfer (RAFT)) processes, among others. The advantages of using a “living” free radical system for polymer brush creation include control over the brush thickness via control of molecular weight and narrow polydispersities, and the ability to prepare block copolymers by the sequential activation of a dormant chain end in the presence of different monomers. These methods are well-detailed in the literature and are described, for example, in an article by Pyun and Matyjaszewski, “Synthesis of Nanocomposite Organic/Inorganic Hybrid Materials Using Controlled/”Living “Radical Polymerization,” Chem. Mater., 2001, 13, 3436-3448, the contents of which are incorporated by reference in its entirety.

If necessary, the first polymerization may be interrupted and a further polymerisation may be started with a new monomer in order to form block polymers.

The term polymer comprises oligomers, cooligomers, polymers or copolymers, such as block, multi-block, star, gradient, random, comb, hyperbranched and dendritic copolymers as well as graft copolymers. The block copolymer unit A contains at least two repeating units (x≧2) of polymerizable aliphatic monomers having one or more olefinic double bonds. The block copolymer unit B contains at least one polymerizable aliphatic monomer unit (y≧0) having one or more olefinic double bonds.

The modified halogenated polymer substrate prepared according to the process of the present invention represents a further embodiment of the present invention.

The modified halogenated polymer can be represented by the following formula:
(1) HalPol-[In-Aₓ-B_{y}-C_{z}-Z]ₙ, wherein
A, B, C represent monomer-oligomer or polymer fragments, which can be arranged in block or statstically;
Z is halogen which is positioned at the end of each polymer brush as end group derived from ATRP;

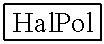

represents the halogenated polymer substrate;
In represents the fragment of a polymerisation initiator capable of initiating polymerisation of ethylenically unsaturated monomers in the presence of a catalyst which activates controlled radical polymerisation;
x represents a numeral greater than one and defines the number of repeating units in A;
y represents zero or a numeral greater than zero and defines the number of monomer, oligopolymer or polymer repeating units in B;
z represents zero or a numeral greater than zero and defines the number of monomer, oligopolymer or polymer repeating units in C;
n is one or a numeral greater than one which defines the number of groups of the partial formula (1a) In-(Aₓ-B_{y}-C_{z}-Z)—.

The subunits A, B, and C can be further subdivided into the general formula (1 b) P-[X]ₙ-E, wherein

P, X, E and n are defined as above.

In the context of the description of the present invention, the term alkyl comprises methyl, ethyl and the isomers of propyl, butyl, pentyl, hexyl, heptyl, octyl, nonyl, decyl, undecyl and dodecyl. An example of aryl-substituted alkyl is benzyl. Examples of alkoxy are methoxy, ethoxy and the isomers of propoxy and butoxy. Examples of alkenyl are vinyl and allyl. An example of alkylene is ethylene, n-propylene, 1,2- or 1,3-propylene.

Some examples of cycloalkyl are cyclopropyl, cyclobutyl, cyclopentyl, cyclohexyl, methylcyclopentyl, dimethylcyclopentyl and methylcyclohexyl. Examples of substituted cycloalkyl are methyl-, dimethyl-, trimethyl-, methoxy-, dimethoxy-, trimethoxy-, trifluoromethyl-, bis-trifluoromethyl- and tris-trifluoromethyl-substituted cyclopentyl and cyclohexyl.

Examples of aryl are phenyl and naphthyl. Examples of aryloxy are phenoxy and naphthyloxy. Examples of substituted aryl are methyl-, dimethyl-, trimethyl-, methoxy-, dimethoxy-, trimethoxy-, trifluoromethyl-, bis-trifluoromethyl- or tris-trifluoromethyl-substituted phenyl. An example of aralkyl is benzyl. Examples of substituted aralkyl are methyl-, dimethyl-, trimethyl-, methoxy-, dimethoxy-, trimethoxy-, trifluoromethyl-, bis-trifluoromethyl or tris-trifluoromethyl-substituted benzyl.

Some examples of an aliphatic carboxylic acid are acetic, propionic or butyric acid. An example of a cycloaliphatic carboxylic acid is cyclohexanoic acid. An example of an aromatic carboxylic acid is benzoic acid. An example of a phosphorus-containing acid is methylphosphonic acid. An example of an aliphatic dicarboxylic acid is malonyl, maleoyl or succinyl. An example of an aromatic dicarboxylic acid is phthaloyl.

The term heterocycloalkyl embraces within the given structure one or two and heterocyclic groups having one to four heteroatoms selected from the group consisting of nitrogen, sulphur and oxygen. Some examples of heterocycloalkyl are tetrahydrofuryl, pyrrolidinyl, piperazinyl and tetrahydrothienyl. Some examples of heteroaryl are furyl, thienyl, pyrrolyl, pyridyl and pyrimidinyl.

An example of a monovalent silyl radical is trimethylsilyl.

The modified halogenated polymer substrate according to the present invention can be used for many applications.

Sensing Devices:

The first requirement for an analytical or sensing device, which allows specific detection or recognition, is the resistance of the device surface towards non-specific adsorption. This requirement can be fulfilled by the copolymers described above. The second requirement is the introduction of functional groups, hereafter called recognition units, that allow specific interaction with selected components of the analyte. Examples are: Recognition units that induce physico-chemical adsorption of a molecule for the subsequent analytical or sensing detection. Examples of the recognition units are any structural unit able to recognize and which will specifically bind (complex) molecules to be analyzed during the sensing step (called target molecules) such as for example organic molecules, biomarkers, metabolites, peptides, proteins, oligonucleotides, DNA or RNA fragments, carbohydrates or fragments thereof. The interaction of the recognition unit and the target molecule will be accomplished by hydrogen bonding, electrostatic interactions, van der Waals forces, C═C interactions, hydrophopic interactions, metal coordination, or combinations thereof.

Examples of recognition units comprise esters, amides, urethanes, carbamates, imides like maleimide or succinimidyl, vinylsulfones, conjugated C═C double bonds, epoxides, aldehydes, ketones, alcohols, ethers, amines, nitrogroups, sulfoxides, sulfones, sulfonamides, thiols, disulfides, silane or siloxane functionalities. These recognition units can react with functional groups of the target molecules.

Recognition units that are able to bind to receptors on the surfaces of cells: a target molecule may be bound to the recognition unit directly by reaction. An example is the reaction of a cysteine-containing peptide to a vinylsulfone recognition unit. The case of the peptide recognition unit binding to receptors on the surface of a cell can be particularly interesting, e.g. in analysis of cellular behavior or in the therapeutic manipulation of cell behavior in a culture system or upon an implant.

Recognition units that are able to bind specifically to a bioactive target moiety: examples of such targets include antigens, proteins, enzymes, oligonucleotides, DNA and RNA fragments, carbohydrates as for example glucose and other groups or molecules provided they are able to interact specifically with the recognition unit in the subsequent analytical or sensing assay.

Recognition units that are able to form stable complexes with a cation. In a second step the cation will form a complex either with the target molecule directly through a suitable functionality. Examples for the recognition unit include carboxylate, amide, phosphate, phosphonate, nitrilo triacetic acid and other known groups that are able to chelate cations. Examples for the cations include Mg(II), Ti(IV), Co(III), Co(VI), Cu(II), Zn(II), Zr(IV), Hf(IV), V(V), Nb(V), Ta(V), Cr(III), Cr(VI), Mo(VI) and other cations known to form stable complexes with chelating ligands.

Many interesting recognition units in the bioanalysis of cellular responses are peptides. In such cases, the peptides may be coupled to the modified halogenated polymer surface (1). The peptide may be bound to the modified halogenated polymer surface (1) through a number of means, including reaction to a cysteine residue incorporated within the peptide. Cysteine residues are rarely involved in cell adhesion directly. As such, few cell adhesion peptides comprise a cysteine residue, and thus a cysteine residue that is incorporated for the purpose of coupling of the peptide will be the unique cysteine residue for coupling. While other approaches are possible, the preferred method is coupling of the peptide to the multifunctional polymer through a cysteine residue on the polymer. Other bioactive features can also be incorporated, e.g. adhesion proteins, growth factor proteins, cytokine proteins, chemokine proteins, and the like. Functionalized surfaces can be used in bioanalytical systems involving cells, in which some effecter of cell function is the measured feature. A test fluid may contain an analyte, to which the response of cells is sought. The cellular response may be used in as a measure of the presence or the activity of the analyte. Alternatively, the cellular response per se may be the knowledge that is sought, e.g. the migration response of a particular cell type to a growth factor, when the cells are migrating upon a particular adhesive substrate. The collection of such scientific information is of significant value in the screening of the activity of drug candidates, particularly when higher order cellular responses such as adhesion, migration, and cell-cell interactions are targeted.

Functionalized surfaces can be used in therapeutic systems involving cells, in which cells are cultured for later therapeutic use. In current therapeutic systems, cultured cells are sometimes used. Examples are in the culture of chondrocytes for transplantation in articular cartilage defects in the knee or in the culture of endothelial cells for transplantation in vascular grafts. In such cases, modulation and manipulation of the phenotype of the cells is of prime interest.

Functionalized surfaces can be used in medical devices. In general a medical device is any article, natural or synthetic, that comprises all or part of a living structure which performs, augments, protects or replaces a natural function and that is substantially compatible with the body.

Any shaped article can be made using the compositions of the invention. For example, articles suitable for contact with bodily fluids, such as medical devices can be made using the compositions described herein. The duration of contact may be short, for example, as with surgical instruments or long term use articles such as implants. The medical devices include, without limitation, catheters, guide wires, vascular stents, micro-particles, electronic leads, probes, sensors, drug depots, transdermal patches, vascular patches, blood bags, and tubing. The medical device can be an implanted device, percutaneous device, or cutaneous device. Implanted devices include articles that are fully implanted in a patient, i.e., are completely internal. Percutaneous devices include items that penetrate the skin, thereby extending from outside the body into the body. Cutaneous devices are used superficially. Implanted devices include, without limitation, prostheses such as pacemakers, electrical leads such as pacing leads, defibrillarors, artificial hearts, ventricular assist devices, anatomical reconstruction prostheses such as breast implants, artificial heart valves, heart valve stents, pericardial patches, surgical patches, coronary stents, vascular grafts, vascular and structural stents, vascular or cardiovascular shunts, biological conduits, pledges, sutures, annuloplasty rings, stents, staples, valved grafts, dermal grafts for wound healing, orthopedic spinal implants, orthopedic pins, intrauterine devices, urinary stents, maxial facial reconstruction plating, dental implants, intraocular lenses, clips, sternal wires, bone, skin, ligaments, tendons, and combination thereof. Percutaneous devices include, without limitation, catheters or various types, cannulas, drainage tubes such as chest tubes, surgical instruments such as forceps, retractors, needles, and gloves, and catheter cuffs. Cutaneous devices include, without limitation, burn dressings, wound dressings and dental hardware, such as bridge supports and bracing components.

Functionalzed surfaces can be used in therapeutic systems involving cells, in which the cells are cultured and used in contact with the surface. As an example of this situation, bioreactors are used in some extracorporal therapeutic systems, such as cultured hepatocytes used to detoxify blood in acute hepatic failure patients. In such cases, one wants to maintain the hepatocytes in the reactor in a functional, differentiated state. The adhesive interactions between the cells and their substrate are thought to play an important role in these interactions, and thus the technology of this invention provides a means by which to control these responses.

Functionalized surfaces can be used in therapeutic systems involving cells, in which the functionalized surfaces are a component of an implant. The interactions between cells in an implant environment and the surface of an implant may play a controlling role in determining the biocompatibility of an implant. For example, on the surface of a stent implanted within the coronary artery, the presence of blood platelets is not desirable and may lead to in-stent restenosis. As such, it would be desirable to prevent the attachment of blood platelets to the stent surface.

The materials described here have a variety of applications in the area of substrates or devices (called ‘chips’ in the general sense) for analytical or sensing purposes. In particular, they are suited for the surface treatment of chips intended to be used in analytical or sensing applications where the aim is specific detection of biologically or medically relevant molecules such as peptides, proteins, oligonucleotides, DNA or RNA fragments or generally any type of antigen-antibody or key-loch type of assays. Particularly if the analyte contains a variety of molecules or ionic species, and if the aim is either to specifically detect one molecule or ion out of the many components or several molecules or ions out of the many components, the invention provides a suitable basis for producing the necessary properties of the chip surface: 1) the ability to withstand non-specific adsorption and 2) the ability to introduce in a controlled way a certain concentration of recognition entities, which will during the analytical or sensing operation interact specifically with the target molecules or ions in the analyte. If combined with suitable analytical or sensor detection methods, the invention provides the feasibility to produce chips that have both high specificity and high detection sensitivity in any type of analytical or sensing assay, in particular in bioaffinity type of assays.

The materials described here additionally have a variety of applications in the area of substrates or devices which are not “chip” based applications. In particular, for use in analytical or sensing applications where the aim is specific detection of biologically or medically relevent molecules such as peptides, proteins, oligonucleotides, DNA or RNA fragments or generally any type of antigen-antibody or key-loch type of assays.

The methods can be applied to chips for any type of qualitative, semiquantitative or quantitative analytical or sensing assay. Particularly suitable detection techniques to be combined with chips include:
1) The optical waveguide technique, where the evanescent field is used to interact with and detect the amount of target molecules adsorbed to the chips surface. The technique relies on incoupling white or monochromatic light into a waveguiding layer through an optical coupling element, preferably a diffraction grating or holographic structure.
2) Fluorescence spectroscopy or microscopy where fluorescently labeled target molecules are quantitatively analyzed by measuring the intensity of the fluorescence light.
3) Combination of 1) and 2), where the evanescent optical field is used to excite the fluorescence tags of target or tracer molecules adsorbed onto the chip surface modified. The fluorescence is detected using a fluorescence detector situated on the side opposite to the liquid flow cell.
4) The Surface Plasmon Resonance Technique (SPR) where the interaction of surface plasmons in thin metal films resonance condition, i.e., the resonant incidence angle for the escitation of a surface plasmon in a thin metal film, is changed upon molecular adsorption or desorption into/from the metal film, due to the resulting change of the effective refractive index.
5) Ultraviolet or Visible (UV/VIS) Spectroscopy where the adsorption at a particular characteristic wavelength is used to quantitfy the amount of target molecules adsorbed or attached to the modified surface.
6) Infrared Techniques such as Fourier Transform Infrared (FTIR) Spectroscopy, where the excitation of atomic or molecular vibrations in the infrared region is used to detect and quantify target molecules that have previously been adsorbed or attached to the surface modified chips. Surface or interface sensitive forms of IR spectroscopy such as Attenuated Total Reflection Spectroscopy (ATR-FTIR) or Infrared Reflection-Adsorption Spectroscopy (IRAS) are particularly suitable techniques.
7) Raman Spectroscopy (RS) to detect specific vibrational levels in the molecule adsorbed or attached onto the modified chip surface. Surface- or interface-sensitive types of RS are particularly suitable, e.g. Surface Enhanced Raman Spectroscopy (SERS).
8) Electrochemical techniques where for example the current or charge for the reduction or oxidation of a particular target molecule or part of that molecule is measured at a given potential. Chip based devices can also be assayed with standard fluorescence or adsorption techniques in which excitation is through light reflected off the substrate surface as opposed to the evanescent field interaction.

Other analytical or bioanalytical device surfaces can be used for qualitative, semiquantitative or quantitative analytical or sensing assays. Non “chip” based substrates also includes fiberoptic substrates. In the case of fiberoptics, techniques as described for “chip” substrates are applicable. For other non “chip” based substrates which do not support evanescent field excitation or are not a “chip”, suitable techniques are described below.
1) Fluorescence spectroscopy or microscopy where fluorescently labeled target molecules are quantitatively analyzed by measuring the intensity of the fluorescence light. The fluorescence is detected using standard detectors positioned either for transmission, or more preferably, for reflection based detection methods.
2) Adsorption spectroscopy where the adsorption at a particular characteristic wavelength is used to quantitfy the amount of target molecules adsorbed or attached to the surface modified according to the invention through reflection or transmission techniques. For simple assay formats such as lateral flow assays, the detection by visual inspection of a color change in the assay region.
3) Infrared Techniques such as Fourier Transform Infrared (FTIR) Spectroscopy, where the excitation of atomic or molecular vibrations in the infrared region is used to detect and quantify target molecules that have previously been adsorbed or attached to the modified chip surface. Surface or interface sensitive forms of IR spectroscopy such as Infrared Reflection-Adsorption Spectroscopy (IRAS) are particularly suitable techniques.
4) Electrochemical techniques where for example the current or charge for the reduction or oxidation of a particular target molecule or part of that molecule is measured at a given potential.

The analytical or sensor chips can be used in a variety of ways.

Non-modified and modified copolymers can be adsorbed onto suitable surfaces either in pure form or as mixtures. The optimum choice depends on the type and concentration of the target molecules and on the type of detection technique. Furthermore, the technique is particularly suited for the modification of chips to be used in assays where multiple analytes are determined on one chip, either sequentially or simultaneously.

Examples are microarrays for multipurpose DNA and RNA bioaffinity analysis ‘Genomics Chips’, for protein recognition and analysis based on sets of antibody-antigen recognition and analyze (Proteomics Chips). Such techniques are particularly efficient for the analysis of a multitude of components on one miniaturized chip for applications in biomedical, diagnostic DNA/RNA, or protein sensors or for the purpose of establishing extended libraries in genomics and proteomics.

From the viewpoint of the detection step, there are two basic alternatives:
1) In a type of batch process where the chip is functionalized. In a fluid manifold, one or several analytes and reagents are locally applied to the chip surface. After awaiting the completion or near completion of the bioaffinity reaction (incubation step), the chip is washed in a buffer and analyzed using one or a combination of the methods described above.
2) In a continuous process where the chip is functionalized and is part of a gaseous or liquid cell or flow-through cell. The conditioning of the surface can be done in a continuous and continuously monitored process within that liquid or flow-through cell, followed by in situ monitoring of the signal due to the specific interaction and adsorption or attachment of the specific target molecule in the analyte solution. The original surface of the chip may afterwards be restored/regenerated again and conditioned for the immediately following next bioaffinity assay. This may be repeated many times.

In a related but different area, the surface treatment of chips has applications in biosensors, where the aim is to attach and organize living cells in a defined manner on such chips. Since protein adsorption and cell attachment is closely related, this opens the possibility to organize cells on chips in defined way.

The detection of specific areas of the pattern can be localized to the specific areas, or can be performed for multiple specific areas simultaneously. In general, an important aspect is the sequential or simultaneous determination of multiple analytes in one or more liquid samples, where the patterned surface is used in microarray assays for the determination of analytes of the group formed of peptides, proteins, antibodies or antigens, receptors or their ligands, chelators or “histidin tag components”, oligonucleotides, polynucleotides, DNA, and RNA fragments, enzymes, enzyme cofactors or inhibitors, lectins, carbohydrates.

In summary, the materials and methods described herein can be used in many application areas, e.g., for the quantitative or qualitative determination of chemical, biochemical or biological analytes in screening assays in pharmacological research, combinatorial chemistry, clinical or preclinical development, for real-time binding studies or the determination of kinetic parameters in affinity screening or in research, for DNA and RNA analytics and the determination of genomic or proteomic differences in the genome, such as single nucleotide polymorphisms, for the determination of protein-DNA interactions, for the determination of regulation mechanisms for mRNA expression and protein (bio)synthesis, for toxicological studies and the determination of expression profiles, especially for the determination of biological or chemical markers, such as mRNA, proteins, peptides or low molecular organic (messenger) compounds, for the determination of antigens, pathogens or bacteria in pharmacological product research and development, human and veterinary diagnostics, agrochemical product research and development, symptomatic and presymptomatic plant diagnostics, for patient stratification in pharmaceutical product development and for the therapeutic drug selection, for the determination of pathogens, harmful compounds or germs, especially of salmonella, prions, viruses and bacteria, especially in nutritional and environmental analytics.

There is a need to improve the selectivity and sensitivity of bioaffinity and diagnostic sensors, especially for use in screening assays and libraries for DNA/RNA and proteins. A common approach to diagnostic sensor design involves the measurement of the specific binding of a particular component of a physiological sample. Typically, physiological samples of interest (e.g. blood samples) are complex mixtures of many components that all interact to varying degrees with surfaces of diagnostic sensors. However, the aim of a diagnostic sensor is to probe only the specific interaction of one component while minimizing all other unrelated interactions. In the case of sensors in contact with blood, proteins, glycoproteins and/or saccharides, as well as cells, often adsorb non-specifically onto the sensor surface. This impairs both selectivity and sensitivity, two highly important performance criteria in bioaffinity sensors.

As outlined above, it is possible to use reactive monomers which directly yield a polyfunctional polymer monolayer according to the invention. Alternatively, monomers can be chosen which carry a precursor of the functional group to be used on the final surface, e.g. an acid chloride or an acid anhydride. They can subsequently be transformed to reactive groups, e.g. NHS ester or glycidylester groups, which allow an interaction of the polymer with sample or probe molecules under the desired conditions.

Thus, all polymerizable monomers are suitable for the purposes of the present invention, as long as they can be combined with, or comprise, functional groups necessary to allow an interaction of the polymer with the sample molecules or probe molecules.

Functional groups which can be used for the purposes of the present invention are preferably chosen according to the molecules with which an interaction is to be achieved. The interaction can be directed to one single type of sample molecule, or to a variety of sample molecules. Since one important application of the present invention is the detection of specific molecules in biological samples, the functional groups present within the polymer brushes will preferably interact with natural or synthetic biomolecules which are capable of specifically interacting with the molecules in biological samples, leading to their detection. Suitable functional moieties will preferably be able to react with nucleic acids and derivatives thereof; such as DNA, RNA or PNA, e.g. oligonucleotides or aptamers, saccharides and polysaccharides, proteins including glycosidically modified proteins or antibodies, enzymes, cytokines, chemokines, peptidhormones or antibiotics or peptides or labeled derivatives thereof.

Since most of the probe molecules, especially in biological or medical applications, comprise sterically unhindered nucleophilic moieties, preferred interactions with the polymer brushes comprise nucleophilic substitution or addition reactions leading to a covalent bond between the polymer chains and the sample or probe molecules.

With appropriate functional groups present in the polymer brushes, the polymer monolayers of the present invention can also be used in separation methods, e.g. as a stationary phase in chromatographic applications.

Preferred functional groups can be chosen from prior art literature with respect to the classes of molecules which are to be immobilized and according to the other requirements (reaction time, temperature, pH value) as described above. Examples for suitable groups are so-called active or reactive esters as N-hydroxy succinimides (NHS-esters), epoxides, preferably glycidyl derivatives, isothiocyanates, isocyanates, azides, carboxylic acid groups or maleinimides.

As preferred functional monomers which directly result in a polyfunctional polymer monolayer, the following compounds can be employed for the purposes of the present invention: acrylic or methacrylic acid N-hydroxysuccinimides, N-methacryloyl-6-aminopropanoic acid hydroxysuccinimide ester, N-methacryloyl-6-aminocapronic acid hydroxysuccinimide ester or acrylic or methacryl acid glycidyl esters.

Depending on the application, there is the possibility of providing a polymer brush with a combination of two or more different functional groups, e.g. by carrying out the polymerization leading to the polymer chains in the presence of different types of functionalized monomers. Alternatively, the functional groups may be identical.

For the detection of a successful immobilization of sample or probe molecules on a polymer monolayer, a variety of techniques can be applied. In particular, it has been found that the polymer layers of the present invention undergo a significant increase in their thickness which can be detected with suitable methods, e.g. ellipsometry. Mass sensitive methods may also be applied.

If nucleic acids, for example oligonucleotides with a desired nucleotide sequence or DNA molecules in a biological sample are to be analyzed, synthetic oligonucleotide single strands can be reacted with the polymer monolayer.

Before the thus prepared surface is used in a hybridization reaction, unreacted functional groups are deactivated via addition of suitable nucleophiles, preferably C.sub.1 C.sub.4 amines, such as simple primary alkylamines (e.g. propyl or butyl amine), secondary amines (diethylamine) or amino acids (glycin).

Upon exposure to a mixture of oligonucleotide single strands, e.g. as obtained from PCR, which are labeled, only those surface areas which provide synthetic strands as probes complementary to the PCR product will show a detectable signal upon scanning due to hybridization. In order to facilitate the parallel detection of different oligonucleotide sequences, printing techniques can be used which allow the separation of the sensor surface into areas where different types of synthetic oligonucleotide probes are presented to the test solution.

The term “hybridization” as used in accordance with the present invention may relate to stringent or non-stringent conditions.

The nucleic acids to be analyzed may originate from a DNA library or a genomic library, including synthetic and semisynthetic nucleic acid libraries. Preferably, the nucleic acid library comprises oligonucleotides.

In order to facilitate their detection in an immobilized state, the nucleic acid molecules should preferably be labeled. Suitable labels include radioactive, fluorescent, phosphorescent, bioluminescent or chemoluminescent labels, an enzyme, an antibody or a functional fragment or functional derivative thereof, biotin, avidin or streptavidin.

Antibodies may include, but are not limited to, polyclonal, monoclonal, chimeric or single chain antibodies or functional fragments or derivatives of such antibodies.

Depending on the labeling method applied, the detection can be effected by methods known in the art, e.g. via laser scanning or use of CCD cameras.

Also comprised by the present invention are methods where detection is indirectly effected.

A further application of the polymer monolayers according to the invention lies in the field of affinity chromatography, e.g. for the purification of substances. For this purpose, polymer brushes with identical functional groups or probe molecules are preferably used, which are contacted with a sample. After the desired substance has been immobilized by the polymer brush, unbound material can be removed, e.g. in a washing step. With suitable eluents, the purified substance can then be separated from the affinity matrix.

Preferred substances which may be immobilized on such a matrix are nucleic acid molecules, peptides or polypeptides (proteins, enzymes) (or complexes thereof, such as antibodies, functional fragments or derivatives thereof), saccharides or polysaccharides.

A regeneration of the surfaces after the immobilization has taken place is possible, but single uses are preferred in order to ensure the quality of results.

With the present invention, different types of samples can be analyzed with an increased precision and/or reduced need of space in serial as well as parallel detection methods. The sensor surfaces according to the invention can therefore serve in diagnostical instruments or other medical applications, e.g. for the detection of components in physiological fluids, such as blood, serum, sputum etc.

Sensors

The sensors of the present invention (i.e., the polymer brush with a probe attached) can also be utilized in a multi-step or “sandwich” assay format, wherein a number of biomolecule targets can be applied or analyzed in sequential fashion. This approach may be useful to immobilize a protein probe for the desired biomolecule target. It may also be applied as a form of signal enhancement if the secondary, tertiary, etc. biomolecules serve to increase the number of signal reporter molecules (i.e., fluorophores).

The sensors can be used to analyze biological samples such as blood, plasma, urine, saliva, tears, mucuous derivatives, semen, stool samples, tissue samples, tissue swabs and combinations thereof.

Sensors in which the tethered probes are polypeptides can be used, for example, to screen or characterize populations of antibodies having specific binding affinity for a particular target antigen or to determine if a ligand had affinity for a particular receptor, according to procedures described generally in Leuking et al., Anal. Biochem., 1991, 270(1):103 111. Target polypeptides can be labeled, e.g., fluorescently or with an enzyme such as alkaline phosphatase, or radio labeling for easy detection.

Probes

A wide variety of biological probes can be employed in connection with the present invention. In general, the probe molecule is preferably substantially selective for one or more biological molecules of interest. The degree of selectivity will vary depending on the particular application at hand, and can generally be selected and/or optimized by a person of skill in the art.

The probe molecules can be bonded to the functional group-bearing polymer segments using conventional coupling techniques (an example of which is further described herein below under the heading “Application”). The probes may be attached using covalently or noncovalently (e.g., physical binding such as electrostatic, hydrophobic, affinity binding, or hydrogen bonding, among others).

Typical polymer brushes functionalities that are useful to covalently attach probes are chosen among hydroxyl, carboxyl, aldehyde, amino, isocyanate, isothiocyanate, azlactone, acetylacetonate, epoxy, oxirane, carbonate sulfonyl ester (such as mesityl or tolyl esters), acyl azide, activated esters (such as N(hydroxy)succinimide esters), O-acyliso-urea intermediates from COOH-carbodiimide adducts, fluoro-aryle, imidoester, anhydride, haloacetyl, alkyliodide, thiol, disulfide, maleimide, aziridine, acryloyl, diazo-alkane, diazo-acetyl, di-azonium, and the like. These may be provided by copolymerizing functional monomers such as 2-hydroethyl(meth)acrylate, hydroxyethyl(meth)acrylamide, hydroxyethyl-N(methyl)(meth)acrylamide, (meth)acrylic acid, 2-aminoethyl(meth)acrylate, amino-protected monomers such as maleimido derivatives of amino-functional monomers, 3-isopropenyl, α,α-dimethylbenzylisocyanate, 2-isocyanato-ethylmethacrylate, 4,4-dimethyl-2-vinyl-2-oxazoline-5-one, acetylacetonate-ethylmethacrylate, and glycidylmethacrylate.

Post derivatization of polymer brushes proves also to be efficient. Typical methods include activation of —OH functionalized groups with, for example phosgene, thiophosgene, 4-methyl-phenyl sulfonylchoride, methylsulfonylchloride, and carbonyl di-imidazole. Activation of carboxylic groups can be performed using carbodiimides, such as 1-ethyl-3-(3-dimethylaminopropyl) carbodiimide hydrochloride, or 1-cyclohexyl-3-(2-morpholinoethyl) carbodiimide, among others. Aldehyde groups can be synthesized from the periodate-mediated oxidation of vicinal —OH, obtained from hydrolysis of epoxy functional brushes. Alternatively, aldehyde groups are attached by reaction of bis-aldehydes (e.g, glutaraldehyde) onto aminomodified polymer brushes. Amino-functional brushes can also be prepared by reacting diamino compound on aminoreactive brushes, such as N(hydroxy)succinimide esters of carboxylates brushes. (Other state-of-the-art coupling chemistries, such as described in Bioconjuguate Techniques, Greg. T. Hermanson, Academic Press, 1996, are also applicable and are incorporated herein by reference.)

Examples of probes used herein include: acetylcholin receptor proteins, histocompatibility antigens, ribonucleic acids, basement membrane proteins, immunoglobulin classes and subclasses, myeloma protein receptors, complement components, myelin proteins, and various hormones, vitamines and their receptor components as well as genetically engineered proteins, nucleic acids and derivatives of, such as DNA, RNA or peptide nucleic acids, oligonucleotides or aptamers, polysaccharides, proteins including glycosidically modified proteins or antibodies, enzymes, cytokines, chemokines, peptidhormones or antibioticsor peptides or labeled derivatives thereof. The probe may be selected from the group consisting of natural or synthetic extracellular proteins, antibodies, antibody fragments, cell adhesion molecules, fragments of cell adhesion molecules, growth factors, cytokines, peptides, sugars, carbohydrates, polysaccharides, lipids, sterols, fatty acids and combinations thereof. More particularly, biomolecules that are contemplated as being suitable for linking with the functionalized monomers or polymer segments contemplated herein in accordance with the invention include, for example:

Bioadhesives, including fibrin; fibroin; Mytilus edulis foot protein (mefpi , “mussel adhesive protein”); other mussel's adhesive proteins; proteins and peptides with glycine-rich blocks; proteins and peptides with poly-alanine blocks; and silks.

Cell Attachment Factors (biomolecules that mediate attachment and spreading of cells onto biological surfaces or other cells and tissues) including molecules participating in cell-matrix and cell-cell interaction during vertebrate development, neogenesis, regeneration and repair, such as molecules on the outer surface of cells like the CD class of receptors on white blood cells, immunoglobulins and haemagglutinating proteins, and extracellular matrix molecules/ligands that adhere to such cellular molecules, ankyrins; cadherins (Calcium dependent adhesion molecules); connexins; dermatan sulfate; entactin; fibrin; fibronectin; glycolipids; glycophorin; glycoproteins; heparan sulfate; heparin sulfate; hyaluronic acid; immunoglobulins; keratan sulfate; integrins; laminins; N-CAMs (Calcium independent Adhesive Molecules); proteoglycans; spektrin; vinculin; and vitronectin.

Biopolymers, including parts of the extracellular matrix which participate in providing tissue resilience, strength, rigidity, integrity, such as alginates; amelogenins; cellulose; chitosan; collagen; gelatins; oligosaccharides; and pectin.

Blood proteins (dissolved or aggregated proteins which normally are present whole blood, which participate in a wide range of biological processes like inflammation, homing of cells, clotting, cell signaling, defence, immune reactions, and metabolism) such as albumin; albumen; cytokines; factor IX; factor V; factor VII; factor VIII; factor X; factor XI; factor XII; factor XIII; hemoglobins (with or without iron); immunoglobulins (antibodies); fibrin; platelet derived growth factors (PDGFs); plasminogen; thrombospondin; and transferrin.

Enzymes (any protein or peptide that has a specific catalytic effect on one or more biological substrates, and which are potentially useful for triggering biological responses in the tissue by degradation of matrix molecules, or to activate or release other bioactive compounds in the implant coating), including Abzymes (antibodies with enzymatic capacity); adenylate cyclase; alkaline phosphatase; carboxylases; collagenases; cyclooxygenase; hydrolases; isomerases; ligases; lyases; metallo-matrix proteases (MMPs); nucleases; oxidoreductases; peptidases; peptide hydrolase; peptidyl transferase; phospholipase; proteases; sucraseisomaltase; TIMPs; and transferases.

Extracellular Matrix Proteins and non-proteins, including ameloblastin; amelin; amelogenins; collagens (I to XII); dentin-sialo-protein (DSP); dentin-sialo-phospho-protein (DSPP); elastins; enamelin; fibrins; fibronectins; keratins (1 to 20); laminins; tuftelin; carbohydrates; chondroitin sulphate; heparan sulphate; heparin sulphate; hyaluronic acid; lipids and fatty acids; and lipopolysaccarides.

Growth Factors and Hormones (molecules that bind to cellular surface structures (receptors) and generate a signal in the target cell to start a specific biological process, such as growth, programmed cell death, release of other molecules (e.g. extracellular matrix molecules or sugar), cell differentiation and maturation, and regulation of metabolic rate) such as Activins (Act); Amphiregulin (AR); Angiopoietins (Ang 1 to 4); Apo3 (a weak apoptosis inducer also known as TWEAK, DR3, WSL-1, TRAMP or LARD); Betacellulin (BTC); Basic Fibroblast Growth Factor (bFGF, FGF-b); Acidic Fibroblast Growth Factor (aFGF, FGF-a); 4-1 BB Ligand; Brain-derived Neurotrophic Factor (BDNF); Breast and Kidney derived Bolokine (BRAK); Bone Morphogenic Proteins (BMPs); B-Lymphocyte Chemoattractant/B cell Attracting Chemokine 1 (BLC/BCA-1); CD27L (CD27 ligand); CD3OL (CD30 ligand); CD4OL (CD40 ligand); A Proliferation-inducing Ligand (APRIL); Cardiotrophin-1 (CT-1); Ciliary Neurotrophic Factor (CNTF); Connective Tissue Growth Factor (CTGF); Cytokines; 6-cysteine Chemokine (OCkine); Epidermal Growth Factors (EGFs); Eotaxin (Eot); Epithelial Cell-derived Neutrophil Activating Protein 78 (ENA-78); Erythropoietin (Epo); Fibroblast Growth Factors (FGF 3 to 19); Fractalkine; Glial-derived Neurotrophic Factors (GDNFs); Glucocorticoid-induced TNF Receptor Ligand (GITRL); Granulocyte Colony Stimulating Factor (G-CSF); Granulocyte Macrophage Colony Stimulating Factor (GM-CSF); Granulocyte Chemotactic Proteins (GCPs); Growth Hormone (GH); 1-309; Growth Related Oncogene (GRO); Inhibins (Inh); Interferon-inducible T-cell Alpha Chemoattractant (I-TAC); Fas Ligand (FasL); Heregulins (HRGs); Heparin-Binding Epidermal Growth Factor-Like Growth Factor (HB-EGF); fms-like Tyrosine Kinase 3 Ligand (Flt-3L); Hemofiltrate CC Chemokines (HCC-1 to 4); Hepatocyte Growth Factor (HGF); Insulin; Insulin-like Growth Factors (IGF 1 and 2); Interferon-gamma Inducible Protein 10 (IP-10); Interleukins (IL 1 to 18); Interferon-gamma (IFN-gamma); Keratinocyte Growth Factor (KGF); Keratinocyte Growth Factor-2 (FGF-10); Leptin (OB); Leukemia Inhibitory Factor (LIF); Lymphotoxin Beta (LT-B); Lymphotactin (LTN); Macrophage-Colony Stimulating Factor (M-CSF); Macrophage-derived Chemokine (MDC); Macrophage Stimulating Protein (MSP); Macrophage Inflammatory Proteins (MIPs); Midkine (MK); Monocyte Chemoattractant Proteins (MCP-1 to 4); Monokine Induced by IFN-gamma (MIG); MSX 1 ; MSX 2; Mullerian Inhibiting Substance (MIS); Myeloid Progenitor Inhibitory Factor 1 (MPIF-1); Nerve Growth Factor (NGF); Neurotrophins (NTs); Neutrophil Activating Peptide 2 (NAP-2); Oncostatin M (OSM); Osteocalcin; OP-1; Osteopontin; OX40 Ligand; Platelet derived Growth Factors (PDGF aa, ab and bb); Platelet Factor 4 (PF4); Pleiotrophin (PTN); Pulmonary and Activation-regulated Chemokine (PARC); Regulated on Activation, Normal T-cell Expressed and Secreted (RANTES); Sensory and Motor Neuron-derived Factor (SMDF); Small Inducible Cytokine Subfamily A Member 26 (SCYA26); Stem Cell Factor (SCF); Stromal Cell Derived Factor 1 (SDF-1); Thymus and Activation-regulated Chemokine (TARC); Thymus Expressed Chemokine (TECK); TNF and ApoL-related Leukocyte-expressed Ligand-1 (TALL-1); TNF-related Apoptosis Inducing Ligand (TRAIL); TNF-related Activation Induced Cytokine (TRANCE); Lymphotoxin Inducible Expression and Competes with HSV Glycoprotein D for HVEM T-lymphocyte receptor (LIGHT); Placenta Growth Factor (PIGF); Thrombopoietin (Tpo); Transforming Growth Factors (TGF alpha, TGF beta 1, TGF beta 2); Tumor Necrosis Factors (TNF alpha and beta); Vascular Endothelial Growth Factors (VEGF-A, B, C and D); calcitonins; and steroid compounds such as naturally occurring sex hormones such as estrogen, progesterone, and testosterone as well as analogues thereof.

DNA Nucleic Acids, including A-DNA; B-DNA; artificial chromosomes carrying mammalian DNA (YACs); chromosomal DNA; circular DNA; cosmids carrying mammalian DNA; DNA; Double-stranded DNA (dsDNA); genomic DNA; hemi-methylated DNA; linear DNA; mammalian cDNA (complimentary DNA; DNA copy of RNA); mammalian DNA; methylated DNA; mitochondrial DNA; phages carrying mammalian DNA; phagemids carrying mammalian DNA; plasmids carrying mammalian DNA; plastids carrying mammalian DNA; recombinant DNA; restriction fragments of mammalian DNA; retroposons carrying mammalian DNA; single-stranded DNA (ssDNA); transposons carrying mammalian DNA; T-DNA; viruses carrying mammalian DNA; and Z-DNA.

RNA Nucleic Acids, including Acetylated transfer RNA (activated tRNA, charged tRNA); circular RNA; linear RNA; mammalian heterogeneous nuclear RNA (hnRNA), mammalian messenger RNA (mRNA); mammalian RNA; mammalian ribosomal RNA (rRNA); mammalian transport RNA (tRNA); mRNA; polyadenylated RNA; ribosomal RNA (rRNA); recombinant RNA; retroposons carrying mammalian RNA; ribozymes; transport RNA (tRNA); viruses carrying mammalian RNA; and short inhibitory RNA (siRNA).

Receptors (cell surface biomolecules that bind signals (such as hormone ligands and growth factors, and transmit the signal over the cell membrane and into the internal machinery of cells) including, the CD class of receptors CD; EGF receptors; FGF receptors; Fibronectin receptor (VLA-5); Growth Factor receptor, IGF Binding Proteins (IGFBP 1 to 4); Integrins (including VLA 1-4); Laminin receptor; PDGF receptors; Transforming Growth Factor alpha and beta receptors; BMP receptors; Fas; Vascular Endothelial Growth Factor receptor (Flt-1); and Vitronectin receptor.

Synthetic Biomolecules, such as molecules that are based on, or mimic, naturally occurring biomolecules.

Synthetic DNA, including A-DNA; antisense DNA; B-DNA; complimentary DNA (cDNA); chemically modified DNA; chemically stabilized DNA; DNA; DNA analogues; DNA oligomers; DNA polymers; DNA-RNA hybrids; double-stranded DNA (dsDNA); hemimethylated DNA; methylated DNA; single-stranded DNA (ssDNA); recombinant DNA; triplex DNA; T-DNA; and Z-DNA.

Synthetic RNA, including antisense RNA; chemically modified RNA; chemically stabilized RNA; heterogeneous nuclear RNA (hnRNA); messenger RNA (mRNA); ribozymes; RNA; RNA analogues; RNA-DNA hybrids; RNA oligomers; RNA polymers; ribosomal RNA (rRNA); transport RNA (tRNA); and short inhibitory RNA (siRNA).

Synthetic Biopolymers, including cationic and anionic liposomes; cellulose acetate; hyaluronic acid; polylactic acid; polyglycol alginate; polyglycolic acid; poly-prolines; and polysaccharides.

Synthetic Peptides, including decapeptides comprising DOPA and/or diDOPA; peptides with sequence “Ala Lys Pro Ser Tyr Pro Pro Thr Tyr Lys” (SEQ ID NO:2); peptides where a Pro is substituted with hydroxyproline; peptides where one or more Pro is substituted with DOPA; peptides where one or more Pro is substituted with di-DOPA; peptides where one or more Tyr is substituted with DOPA; peptide hormones; peptide sequences based on the above listed extracted proteins; and peptides comprising an RGD (Arg Gly Asp) motif. Recombinant Proteins, including all recombinantly prepared peptides and proteins.

Synthetic Enzyme Inhibitors, including metal ions, that block enzyme activity by binding directly to the enzyme, molecules that mimic the natural substrate of an enzyme and thus compete with the principle substrate, pepstatin; poly-prolines; D-sugars; D-aminocaids; Cyanide; Diisopropyl fluorophosphates (DFP); N-tosyl-1-phenylalaninechloromethyl ketone (TPCK); Physostigmine; Parathion; and Penicillin.

Vitamins (Synthetic or Extracted), including biotin; calciferol (Vitamin D's; vital for bone mineralisation); citrin; folic acid; niacin; nicotinamide; nicotinamide adenine dinucleotide (NAD, NAD+); nicotinamide adenine dinucleotide phosphate (NADP, NADPH); retinoic acid (vitamin A); riboflavin; vitamin B's; vitamin C (vital for collagen synthesis); vitamin E; and vitamin K's.

Other Bioactive Molecules including adenosine di-phosphate (ADP); adenosine monophosphate (AMP); adenosine tri-phosphate (ATP); amino acids; cyclic AMP (cAMP); 3,4-dihydroxyphenylalanine (DOPA); 5′-di(dihydroxyphenyl-L-alanine (diDOPA); diDOPA quinone; DOPA-like o-diphenols; fatty acids; glucose; hydroxyproline; nucleosides; nucleotides (RNA and DNA bases); prostaglandin; sugars; sphingosine 1-phosphate; rapamycin; synthetic sex hormones such as estrogen, progesterone or testosterone analogues, e.g. Tamoxifene; estrogen receptor modulators (SERMs) such as Raloxifene; bisphosphonates such as alendronate, risendronate and etidronate; statins such as cerivastatin, lovastatin, simvaststin, pravastatin, fluvastatin, atorvastatin and sodium 3,5- dihydroxy-7-[3-(4-fluorophenyl)-1-(methylethyl)-1H-indol-2-yl]-hept-6-enoate, drugs for improving local resistance against invading microbes, local pain control, local inhibition of prostaglandin synthesis; local inflammation regulation, local induction of biomineralisation and local stimulation of tissue growth, antibiotics; cyclooxygenase inhibitors; hormones; inflammation inhibitors; NSAID's (non-steroid antiinflammatory agents); painkillers; prostaglandin synthesis inhibitors; steroids, and tetracycline (also as biomineralizing agent). [0049] Biologically Active Ions, including ions which locally stimulate biological processes like enzyme function, enzyme blocking, cellular uptake of biomolecules, homing of specific cells, biomineralization, apoptosis, cellular secretion of biomolecules, cellular metabolism and cellular defense, such as calcium; chromium; copper; fluoride; gold; iodide; iron; potassium; magnesium; manganese; selenium; sulphur; stannum (tin); silver; sodium; zinc; nitrate; nitrite; phosphate; chloride; sulphate; carbonate; carboxyl; and oxide.

Marker Biomolecules, (which generate a detectable signal, e.g. by light emission, enzymatic activity, radioactivity, specific colour, magnetism, X-ray density, specific structure, antigenicity etc., that can be detected by specific instruments or assays or by microscopy or an imaging method like x-ray or nuclear magnetic resonance, for example which could be employed to monitor processes like biocompatibility, formation of tissue, tissue neogenesis, biomineralisation, inflammation, infection, regeneration, repair, tissue homeostasis, tissue breakdown, tissue turnover, release of biomolecules from the implant surface, bioactivity of released biomolecules, uptake and expression of nucleic acids released from the implant surface, and antibiotic capability of the implant surface to demonstrate efficacy and safety validation prior to clinical studies, including calcein; alizaran red; tetracyclins; fluorescins; fura; luciferase; alkaline phosphatase; radiolabeled aminoacids or nucleotides (e.g. marked with ³²P, ³³P, ³H, ³⁵S, ¹⁴C, ¹²⁵I, ⁵¹Cr, ⁴⁵Ca); radiolabeled peptides and proteins; radiolabeled DNA and RNA; immuno-gold complexes (gold particles with antibodies attached); immunosilver complexes; immuno-magnetite complexes; Green Fluorescent protein (GFP); Red Fluorescent Protein (E5); biotinylated proteins and peptides; biotinylated nucleic acids; biotinylated antibodies; biotinylated carbon-linkers; reporter genes (any gene that generates a signal when expressed); propidium iodide; and diamidino yellow.

The probe can also be a cell. The cells can be naturally occurring or modified cells. In some embodiments, the cells can be genetically modified to express surface proteins (e.g., surface antigens) having known epitopes or having an affinity for a particular biological molecule of interest. Examples of useful cells include blood cells, liver cells, somatic cells, neurons, and stem cells. Other biological polymers can include carbohydrates, cholesterol, lipids, etc.

While biological molecules can be useful as probes in many applications, the probe itself can be a non-biological molecule. In one case, the dye probe can be used for selective biomolecule recognition, as generally described herein. Non-biological probes can also include small organic molecules that mimic the structure of biological ligands, drug candidates, catalysts, metal ions, lipid molecules, etc. Also, dyes, markers or other indicating agents can be employed as probes in the present invention in order to enable an alternative detection pathway. A combination of dyes can also be used. Dyes can also be used, in another case, as a substrate “tag” to encode a particular substrate or a particular region on a substrate, for post-processing identification of the substrate (polymer probe or target).

Surfaces according to the present invention can also immobilize starter molecules for synthetic applications in particular in solid phase synthesis, e.g. during the in situ formation of oligo- or polymers. Preferably, the oligo- or polymers are biomolecules and comprise peptides, proteins, oligo- or polysaccharides or oligo- or polynucleic acids. As immobilized initiators, a monomer of these macromolecules can be used.

Among the several features of the present invention therefore, is the provision of a polymer brush for selectively interacting with biomolecules having improved stability when exposed to an aqueous environment; the provision of such a brush wherein improved stability in aqueous environments is achieved by the presence of hydrophobic polymer chains on the substrate surface of the brush, forming a hydrophobic layer of a controlled thickness; the provision of such a brush wherein polymer chains having a water-soluble or water-dispersible segment having functional groups capable of bonding to a probe are attached to the hydrophobic polymer chains; the provision of such a brush wherein the molecular weight and/or density of the hydrophobic polymer chains is controlled to optimize bond stability to the substrate surface; and, the provision of such a brush wherein the density of the water-soluble or water-dispersible polymer segments is controlled independent of the hydrophobic polymer chain density, and further is controlled to optimize functional group accessibility for probe attachment and/or probe accessibility for the attachment of a molecule of interest.

Further among the features of the present invention is the provision of a polymer brush for selectively interacting with biomolecules wherein water-soluble or water-dispersible polymers, associated with the substrate surface of the brush, contain functional groups which attach probes without the need for chemical activation.

Still further among the features of the present invention is the provision of a sensor for selectively interacting with biomolecules wherein polymer chains bound to the substrate surface of the sensor have water-soluble or water-dispersible segments which contain the residue of a monomer having a probe for binding the biomolecule already attached thereto.

Still further among the features of the present invention is the provision of a polymer brush for selectively interacting with biomolecules wherein a low density of water-soluble or water-dispersible polymer segments are directly or indirectly attached to the substrate surface of the brush, in order to optimize functional group accessibility for the attachment of large diameter probes and/or probe accessibility for the attachment of large diameter molecules.

Still further among the features of the present invention is the provision of process for preparing a polymer brush for selectively interacting with biomolecules, wherein multiple polymer layers are present on the substrate surface of the brush; the provision of such a process wherein living free radical polymerization is employed to grow a first polymer layer from the surface; and, the provision of such a process wherein, prior to growth of a second polymer layer from the first, a portion of the “living” polymer chain ends are deactivated or terminated, such that additional polymer chain growth does not occur, in order to control the polymer chain density of the second layer.

The present invention is further directed to methods for preparing the polymer brushes of the present invention. For example, the present invention is further directed to a method of preparing a polymer brush for binding a molecule in an aqueous sample in an assay, wherein the method comprises forming a hydrophobic layer on a substrate surface having a dry thickness of at least about 50 angstroms, and then forming a hydrophilic layer on said hydrophobic layer.

Devices that comprise polymer surfaces microstamped by the methods of the present invention are thus also an aspect of the invention. As will be apparent to those of ordinary skill in the art, the direct binding of biological and other ligands to polymers is important in many areas of biotechnology including, for example, production, storage and delivery of pharmaceutical proteins, purification of proteins by chromatography, design of biosensors and prosthetic devices, and production of supports for attached tissue culture. The present methods find use in creating devices for adhering cells and other biological molecules into specific and predetermined positions. Accordingly, one example of a device of the present invention is a tissue culture plate comprising at least one surface microstamped by the method of the present invention. Such a device could be used in a method for culturing cells on a surface or in a medium and also for performing cytometry.

The present invention is also directed to coat materials for their use as implants and medical devices.

The material to be coated may also be any blood-contacting material conventionally used for the manufacture of renal dialysis membranes, blood storage bags, pacemaker leads or vascular grafts. For example, the material to be modified on its surface may be a polyurethane, polydimethylsiloxane, polytetrafluoroethylene, polyvinylchloride, Dacron™ or Silastic™ type polymer, or a composite made therefrom.

The form of the material to be coated may vary within wide limits. Examples are particles, granules, capsules, fibres, tubes, films or membranes, preferably moldings of all kinds such as ophthalmic moldings, for example intraocular lenses, artificial cornea or in particular contact lenses.

Another interesting aspect of polymer brushes is their potential for affecting a variety of different surface properties, ranging from adhesion to tribology on many different substrates, and the ability of tuning these properties using an external stimulus. This implicates applications such as coatings for corrosion protection to high-tech applications such as controlled-release biocoatings.

Polymer brushes are well-suited for the fabrication of nano- or micropatterned arrays with control over chemical functionality, shape, and feature dimension and interfeature spacing on the micron and nanometer length scales. These characteristics make polymer brushes attractive for a variety of biotechnological applications including their use in molecular recognition, biosensing, protein separation and chromatography, combinatorial chemistry, scaffolds for tissue engineering, and micro- and nanofluidics.

Adhesion

Whether one considers its promotion or inhibition, adhesion is of fundamental importance.

Microbial adhesion is a serious complication after the insertion of biomaterials implants or devices in the human body and depends on the physicochemical surface properties of the adhering microorganisms and the biomaterial. Polymer brushes increase the distance between microorganisms and a substratum surface by entropic effects, therewith reducing the attractive forces between surface and the microorganisms.

Biosurfaces

Considerable effort has been made to develop biomaterials that possess good mechanical properties and biocompatibility. However, they suffer from a variety of problems, including poor surface attachment of cells and tissues. The development of new biomaterials that have all of the desired properties is costly, and current efforts are focused on using presently available biomaterials, but with designed surfaces. Both adhesion and the inhibition of adhesion are important when considering applications involving biosurfaces (e.g., artificial implants, cell culture dishes, biosensors). Many surfaces have been functionalized with proteins and cells by physisorption and “grafting to” methodologies.

Poly(vinylidene difluoride) (PVDF) is used as a biomaterial in soft tissue applications. Although its material properties are well-suited for this application, improved adhesion of proteins and peptides that promote integrin-mediated cell attachment is desired. Tissue compatibility is engineered by creating poly(acrylic acid) polymer brushes (plasma-induced SIP) on the PVDIF surface and converting the acid-fiznctionalized brush to a fibronectin-coated surface by carbodümide coupling reactions, and studied by comparative exposure of the modified surface.

Polymer brushes have also found use in this arena particularly through the use of surface-attached stimuli-responsive polymers to make “smart” bioconjugates using smart polymers and receptor proteins. The use of external stimuli (e.g., pH, electric field, light, temperature, solvency) to effect a change in polymer properties has also been found to be very useful for controlling adhesion on biosurfaces. The change usually comes about from a change in conformation which affects hydrophobicity/hydrophilicity and thus the surface energetics of a surface-attached polymer. Many stimuli-responsive polymers are known, and many studies have been made with those based on poly(N isopropylacrylamide).

Temperature-responsive surfaces can be created from poly(111PAAM) polymer brushes (via electron beam-initiated polymerization) on tissue culture polystyrene substrates and are used to investigate inflammatory cell adhesion behavior. At elevated temperature, human monocyte and monocyte-derived macrophages are able to adhere, spread, and fuse to form foreign body giant cells (FBGC) on the hydrophobic surface. Cell detachment is accomplished by lowering the temperature of the brush-coated surface below the LCST Differential macrophage detachment.

Cell Growth Control

Control of cell growth can be accomplished by attaching cells to a surface, allowing them to proliferate and grow, followed by their detachment. Cell attachment and proliferation is a facile process, particularly for hydrophobic surfaces, whereas detachment requires sophistication to recover cells without damage. Thermoresponsive polymer brushes, with their ability to control hydrophobic/hydrophilic properties, were investigated to determine their efficacy in this process.

Surface-attached polymers (i.e., both “grafting to” and “grafting from) can be used to control cell growth using protein-repellent micropatterns based on poly(acrylamide)/PEG copolymers, comb polymers, and polycationic PEG-grafted copolymers.

Another major field of application for polymer brushes, already widely explored for SAMs, is molecular recognition in which biocompatible and non-biofouling PEG or poly(2-methacryloyloxyethyl phosphorylcholine)-containing polymer brushes are patterned onto surfaces by various lithographic techniques. Subsequently, the unpatterned regions may be backfilled with a biomolecule that gives rise to specific interactions with cells or other biomolecules such as proteins and peptides.

Nonfoulinq Biosurfaces

Recently, polymer brush-coated surfaces provide nonfouling properties. Extracellular proteins adsorb strongly on many surfaces through hydrophobic interactions. This is useful for making biocoatings.

Tribology

The ability to control surface properties at the nanoscale holds great promise for polymer brushes. Polyelectrolyte polymer brushes have superior lubrication properties; compared to neutral brushes, and to display effective friction coefficients less than 0.0006-0.001 at low sliding velocities (250-500 nm s-1) and at loading pressures of several atmospheres in aqueous environments.

Surface Coatings

The wettability of a surface is an important property for many applications, and is essential for the creation of an adhesive bond when joining two substrates together, during application of a coating to a substrate and during the creation of almost any interface. Whether the resuiting surface is to be hydrophobic or hydrophilic is highly application-dependent. Super hydrophobic surfaces can be created by controlling surface morphology using nanostructures and patterned polymers. The use of grafted polymers has been used to control wetting in many applications. The control of fiber surface hydrophobicity, wetting, and adhesion properties is important in composite formation. Polymer brushes are prepared on cellulose fibers by grafting from ATRP of methyl acrylate.

Surfaces decorated with poly(4-vinyl-N-methylpyridinum) iodide polyelectrolyte brushes serve as substrates for the preparation of welldefined polyelectrolyte multilayers via layer-by-layer deposition. Strong electrostatic forces and low solubility of the surface-bound polycation/solution-phase polyanion complex result in nonstoichiometric film formation and collapse of this newly formed film to thicknesses near the dry film thickness.

Coatings can be prepared on electrically conductive substrates using electrochemical polymerization. The coatings prepared by this process tend to have highly desirable properties such as good adhesion. Moreover, they can be formed on virtually any shaped substrate, and processing can be simplified by the elimination of primers. Thicker coatings can be produced by sequentially coupling cathodic electropolymerization with another polymerization method. In this way, polymer brushes have been produced on electrically conductive surfaces (e.g., steel, copper etc).

Other applications for polymer brushes include coatings that would provide a barrier to prevent corrosive substances from penetrating and damaging a substrate. they could make new lubricants in industrial settings.

Responsive Smart Surfaces

Dependent on the polymer architecture the surface properties (for example surface energy, i.e. wettability/hydrophobicityund, transparency, light absorption, biologic properties like cell adhesion and microbicidal activity etc.) of the substrates can optionally be influenced and changed by external stimuli (solvent parameters, temperature, light, electric fileds).

As a result of this ability to change properties, such polymer brushes are sometimes referred to a stimulus responsive, “switchable” or “smart”.

Now, increasing attention is being paid to the development of responsive smart surfaces that respond to external stimuli, e.g., light, temperature, electricity, pH, and solvent. Photoswitchable functions of films or surfaces are desirable for many promising applications. It is noteworthy that for the construction of smart devices, to graft photoactive molecules or to prepare photoactive coatings on surfaces is an important and useful route to endow smart devices with some unique photoresponsive physical properties, such as wettability, friction, biocompatibility, and optical properties.

Stimuli-Responsive and Switchable Surfaces

The use of stimuli-responsive polymer brushes is very useful in the control of adhesion, particularly in biological applications.

Surface morphology and water contact angle are modified by simply by changing the solvent to which the block copolymer brush was exposed. Polystyrene-b-poly(methyl methacrylate) (PS-b-PMMA) brushes were smooth (RMS roughness=0.77 nm; contact angle −74°) when exposed to CHZCIZ, but became rougher (RMS=1.79 nm; contact angle=99° after exposure to cyclohexane.

An interesting application of stimuli-responsive polymer brush surfaces uses a mixed brush composed of poly(2-vinylpyridine) and polyisoprene to write permanent patterns onto a surface that has been patterned via photolithography—a process termed “environment-responsive lithography”. Solvent switching provides both the stimulus for creating and erasing the pattern. UV radiation during the photolithography step crosslinks the polyisoprene in the mixed brush, and this causes a loss of switching properties for the surface in that region. Imaging relies on the contrast that develops between parts of the surface that have been irradiated and masked when exposed to solvent.

Further Potential Applications

Separations

The separation of mixtures into their components is an extremely important process that impacts on all branches of chemistry, and especially on biological areas where the isolation of pure substances is critical to their use in humans.

Membranes

The attachment of polymer brushes to membranes can impact a variety of fluid flow properties. One might envision that appropriately functionalized membrane surfaces can improve or enhance separation and resolution through selective adsorption of one component in a mixture. Chiral surfaces could be used for resolving enantiomeric mixtures of medicinal products.

Another application of polymer brushes involves their use as microvalves to control flow. This idea of using two closely spaced polymer brushes as a gate to control fluid flow has been explored both theoretically and experimentally.

Microfluidics

The development of microfluidic devices is a rapidly growing field which has important implications for bioanalytical analysis, studying reactions in microreactors, and understanding fluid mixing under flow. Interest exists in the possibility that, through the use of patterned polymer brushes in a microfluidics channel, mixing and fluid flow in the device can be controlled.

Microelectronics

Photovoltaics

Polymer Brushes can serve as a substrate for the fabrication of photovoltaic devices. The suitable polymer serves as an electron hole transporting component, which together with semiconducting nanocrystals forms a heterojunction photovoltaic diode with high quantum yields (W. T. S. Huck et al. Nano Lett. 2005, 5, 1653-1657)

Electroless Plating

Metalilization of polymeric substrates is of major importance on the way to flexible electronics. Polymer Brushes offer a possibility for the site selective metal deposition for the fabrication of flexible microelectronics. (W. T. S. Huck et al. Langmuir 2006, 22, 6730-6733).

Transistor Fabrication

The use of organic materials in electronic devices such as field effect transistors or light emmiting diodes is an attractive approach doe decrease weight and cost, simplify the production process and increase the versatility of such devices. The polymeric dielectric layer for such devices should be pinhole-free, with controllable thickness and composition. Polymer brushes offer these characteristics and it was shown, that field effect transistors can be fabricated with them (R. H. Grubbs et al. J. Am. Chem. Soc. 2004, 126, 4062-4063)

The following examples illustrate the present invention without limiting its scope.

### EXAMPLE 1

A solid PVC film is prepared by casting a 20% solution of PVC granulate (av. mol weight 60000d, Sigma-Aldrich) in THF on an appropriate support using a wire bar system (approx. 1 mm layer thickness). After 2 h drying on air the film is lifted off and reacted in 250 ml of a 25% aqueous NaN₃ solution and n-tetrabutylammonium bromide (c=40 mmol/1) at 80° C.

For purification the film is treated with water in an ultrasonic bath.

IR spectra clearly show an azidation of the surface.

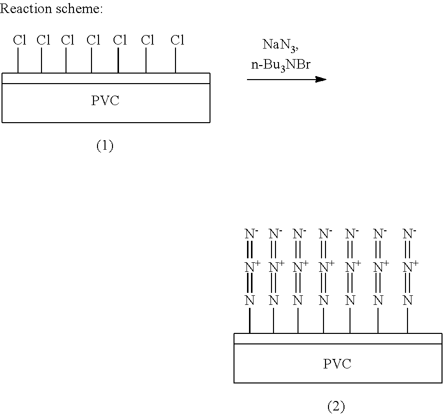

After activation of the PVC substrate a suitable initiator can be covalently bonded at the surface via a copper-catalysed 1,3-dipolar addition.

### EXAMPLE 2

The PVC film as prepared in Example 1 together with 3.6 g of the alkin-initiator are added to 250 ml of a mixture of DMF and water (5:1), heated up to 65° C. and stirred at this temperature for 1 h.

Then a solution of CuSO₄ (30 mg in 5 ml H₂O) and a solution of sodium ascorbate (127 mg in 5 ml H₂O) are added and stirred over night.

The obtained film has to be extracted for 24 h with diethyl ether in order to obtain a smooth surface.

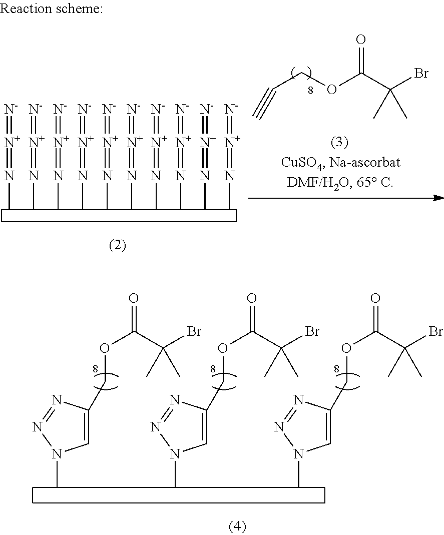

### EXAMPLE 3

Alternatively to the processes as described in Examples 1 and 2 the PVC substrate can also be reacted with a thiol-substituted initiator.

In this case the sulfur reacts as a nucleophile and the initiator is bonded at the PVC surface by substitution of the chlorine.

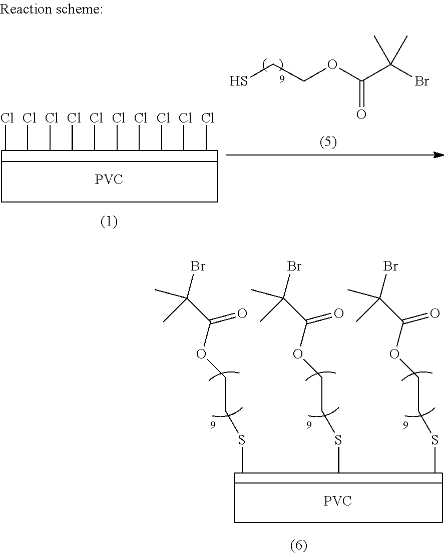

### EXAMPLE 4

33.4 g (119.7 mmol) of (7) is exhibited in a mixture of methanol and water. After addition of 933.8 mg (5.978 mmol) bipiridyl and 53 mg (0.238 mmol) copper(II)bromide the solution is degassed with nitrogen.

343 mg (2.394 mmol) copper(I)bromide and the activated film are added to the degassed solution. The reaction mixture is agitated for 1 h at room temperature.

For completion of the reaction the film is removed from the reaction mixture, washed in an ultrasonic bath and dried.

The film shows a mass increase of 6.3 mg.

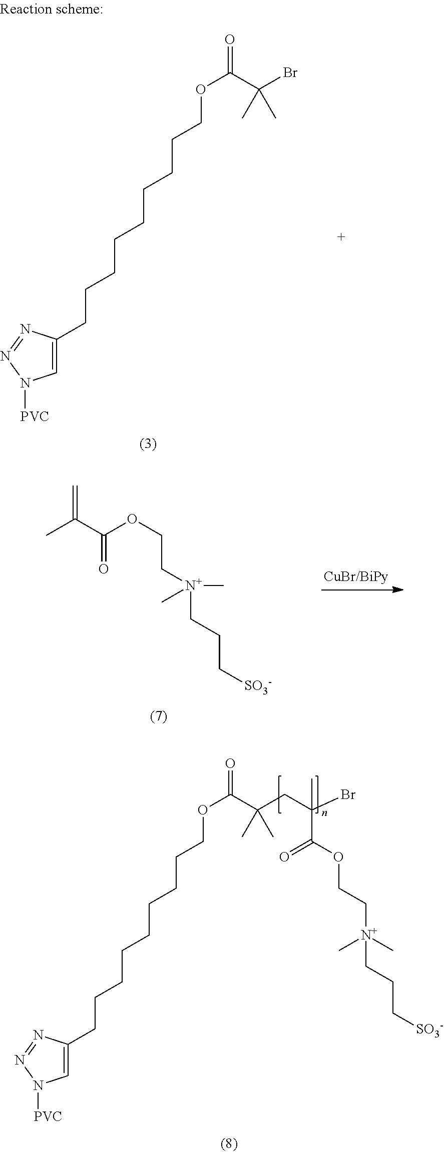

The elemental composition of the PVC sample surface is measured with ESCA technique. The size of the analyzed area is 100 micrometers in diameters. The depth of the analysis is 5 nanometers.

The results in the table below are averages of the two measurements.

Surface elemental composition (atomic %) of the PVC sample

| Sample | C | O | N | S |
|---|---|---|---|---|
| PVC | 66.4 | 25.3 | 4.5 | 4.0 |

### EXAMPLE 5

2 ml (14.0 mmol) of (9) is exhibited in a mixture of methanol and water. After addition of 28 mg (0.178 mmol) bipiridyl and 2 mg (0.008 mmol) of copper(II)bromide the solution is degassed with nitrogen.

12 mg (0.081 mmol) copper(I)bromide and the activated film are added to the degassed solution. The reaction mixture is agitated for 2 h at room temperature.

For completion of the reaction the film is removed from the reaction mixture, washed in an ultrasonic bath and dried.

The film shows a mass increase of 4.8 mg.

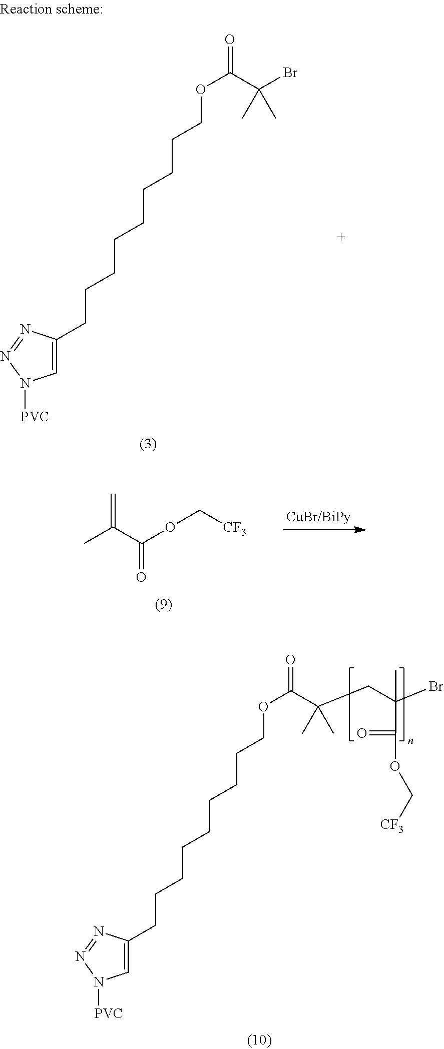

### EXAMPLE 6

4.3 ml (14.0 mmol) of (11) is exhibited in a mixture of methanol and water. After addition of 28 mg (0.178 mmol) bipiridyl and 2 mg (0.008 mmol) of copper(II)bromide the solution is degassed with nitrogen.

12 mg (0.081 mmol) copper(I)bromide and the activated film are added to the degassed solution. The reaction mixture is agitated for 2 h at room temperature.

For completion of the reaction the film is removed from the reaction mixture, washed in an ultrasonic bath and dried.

The film shows a mass increase of 4.8 mg.

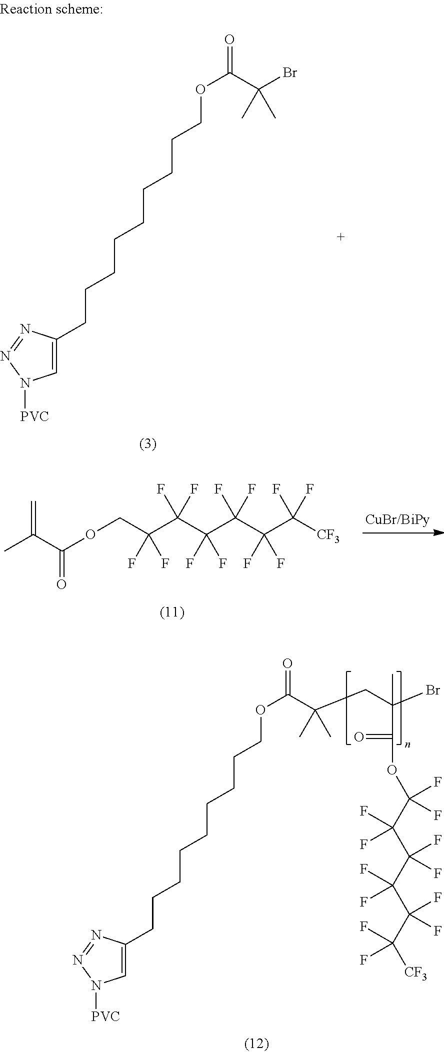

### EXAMPLE 7

3.39 ml (13.3 mmol) of (13) is exhibited in iso-propanol.

After addition of 52 mg (0.226 mmol) Me₆TREN and 1.2 mg (0.007 mmol) of copper(II)chloride the solution is degassed with nitrogen.

9 mg (0.091 mmol) copper(I)chloride and the activated film are added to the degassed solution. The reaction mixture is agitated for 64 h at 65° C.

For completion of the reaction the film is removed from the reaction mixture, washed in an ultrasonic bath and dried.

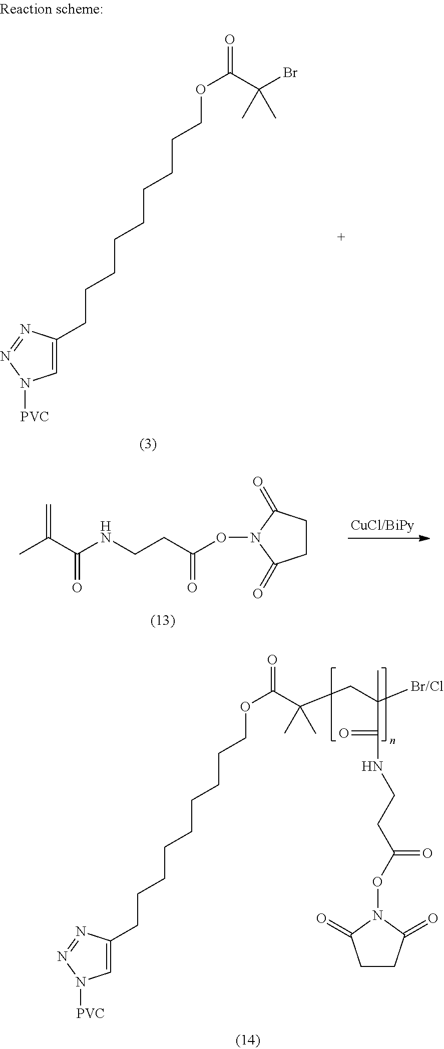

### EXAMPLE 8

11.6 g (42.8 mmol) of (15) is exhibited in a mixture of methanol and water.

After addition of 196 mg (1.255 mmol) bipiridyl and 15 mg (0.067 mmol) of copper(II)bromide the solution is degassed with nitrogen.

73 mg (0.506 mmol) copper(I)bromide and the activated film are added to the degassed solution. The reaction mixture is agitated for 16 h at room temperature.

For completion of the reaction the film is removed from the reaction mixture, washed in an ultrasonic bath and dried.

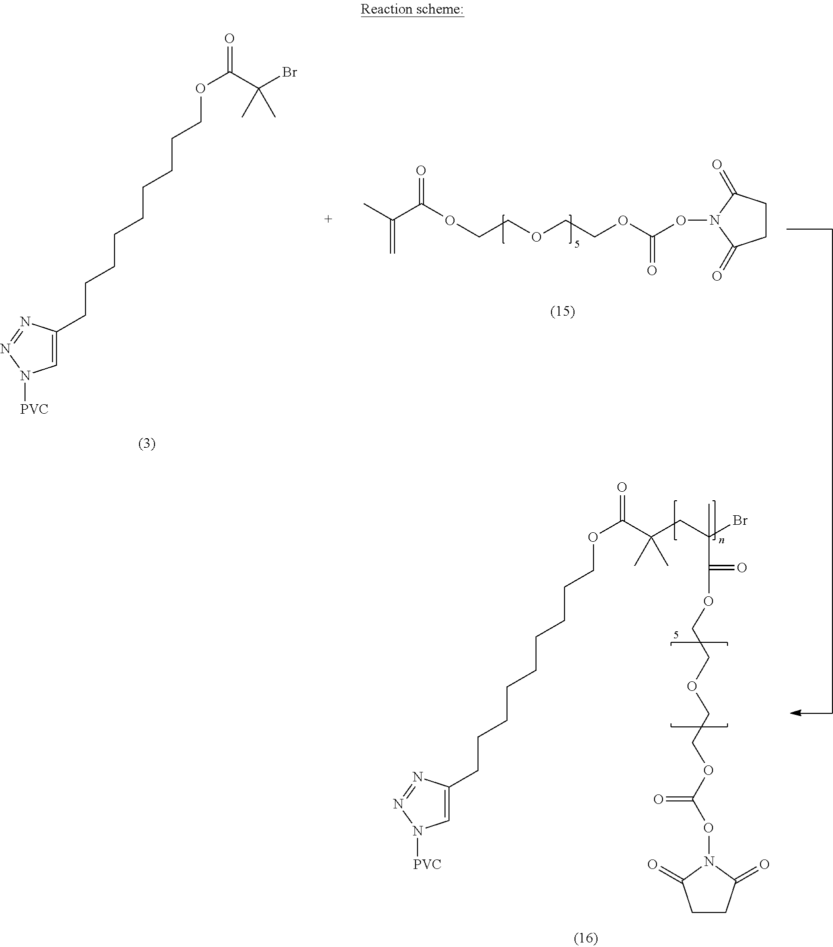

### EXAMPLE 9

Labelling of BSA:

50 mg of BSA (bovine serum albumine, Thermo Scientific) were dissolved in 20 mM phosphate buffer (pH 7.4). To the solution of BSA in phosphate buffer was added 0.5 eq Tris(2-carboxyethyl)phosphine hydrochloride and the mixture was incubated at room temperature for 10 min. Afterwards, 6 eq of N-(5-Fluoresceinyl)maleimide (F5M, Sigma-Aldrich)) was added and the solution was shaken for 5 hours at room temperature. The labelled BSA was isolated using centrifugal filter units. The labelled BSA was centrifuged and washed with PBS buffer, until no absorbance of the F5M (absorbance maximum 492 nm) was detected using UV spectroscopy. The concentrated solution containing the labelled BSA was transferred into an eppendorf tube and stored at −20° C.

### EXAMPLE 10

Covalent Immobilization of BSA:

PVC sheet (1 cm²) 1, PVC carrying polymer brushes with PEG (1 cm²) 2 and PVC carrying polymer brushes with PEG-activated ester group (1 cm²) 3 was placed into separate eppendorf vials. To each of the vials was added 1 mL solution of fluorescently labelled BSA in 100 mM NaHCO₃ buffer pH 8.3. The sheets were shaken at room temperature for 3 hours, afterwards the foils was gently removed from the vials and washed extensively with 100 mM Na-HCO₃, and stored at 4° C. The foils were analyzed using fluorescent microscopy. No fluorescence was detected on untreated PVC sheet and PVC with PEG-polymer brushes. PVC with grafted PEG-activated ester group exhibited significant fluorescense response.

### EXAMPLE 11

Quantification of Immobilized BSA with Bradford Assay

Bradford Assay:

Standard solutions of BSA with concentration from 2 mg/mL to 0 mg/mL were prepared. Five different samples of PVC film (prepared as described above) (1 cm²) were incubated with a solution of (0.5 mg/mL) BSA in 100 mM sodium carbonate buffer pH 8.3 at room temperature. Sample 1—PVC foil, Sample 2—PVC, carrying polymer brushes with betaine, Sample 3—PVC, bearing polymer brushes with PEG, Sample 4—PVC, bearing polymer brushes with PEG and an activated group. The samples were incubated for five hours at room temperature. Samples of 50 μL were taken from each solution after 0 min, 1 hour, 2 hours, 3 hours and 5 hours. The samples were mixed with 1.5 mL of solution containing the Bradford assay (Thermo Scientific), the mixture incubated at room temperature for additional 10 min and the absorbance was measured at 465 nm. The protein concentration in solution was determined using the standard curve obtained for BSA.

LEGEND TABLE 1
Protein concentration samples 1-4

| Time | | | | |
|---|---|---|---|---|
| (hours) | Sample 1 | Sample 2 | Sample 3 | Sample 4 |
| 0 | 0.49753 | 0.5 | 0.5 | 0.5 |
| 1 | 0.49411 | 0.49574 | 0.49669 | 0.49697 |
| 2 | 0.48857 | 0.49574 | 0.49669 | 0.49577 |
| 3 | 0.48857 | 0.49574 | 0.49669 | 0.49577 |
| 5 | 0.48223 | 0.49574 | 0.49669 | 0.49422 |

1. A method of preparing a modified halogenated polymer surface, comprising the steps of
(a) activating the surface by modification with a polymerization initiator by
(a₁) reaction of the halogenated polymer surface with sodium azide and subsequent
(a₂) 1,3 dipolar cycloaddition with an alkine-functionalized initiator; or
(a₃) reaction of the halogenated polymer surface with a mercapto-functionalized initiator; and
(b) reacting the activated surface obtained in steps (a₁)/(a₂) or (a₃) with polymerizable monomeric units A and/or B.

2. Method according claim 1, wherein the initiator represents the fragment of a polymerization initiator capable of initiating polymerization of ethylenically unsaturated monomers in the presence of a catalyst which activates controlled radical polymerization.

3. Method according to claim 1, wherein the polymerizable monomeric units A and B are copolymerized by atom transfer radical polymerization (ATRP) participating the initiator of the activated surface obtained in steps (a₁)/(a₂) or (a₃).

4. Method according to claim 3, wherein the initiator represents the fragment of a polymerization initiator capable of initiating polymerization of ethylenically unsaturated monomers in the presence of a catalyst which activates controlled radical polymerization.

5. Method according to claim 1, wherein the initiator is selected from the group consisting of C₁-C₈alkylhalides, C₆-C₁₅-aralkylhalides, C₂-C₈-haloalkyl esters, arene sulphonyl chlorides, haloalkanenitriles, α-haloacrylates and halolactones.

6. Method according to claim 1, wherein the polymerizable monomeric units A and B differ in polarity and contain one or more olefinic double bond.

7. Method according to claim 1, wherein the polymerizable monomeric units A and B are selected from styrenes, acrylic acid, C₁-C₄-alkylacrylic acid, amides, anhydrides orand salts of acrylic acid or C₁-C₄-alkylacrylic acid, acrylic acid-C₁-C₂₄-alkyl esters and C₁-C₄-alkylacrylic acid-C₁-C₂₄-alkyl esters.

8. Method according to claim 1, wherein the polymerizable monomeric units A and B are selected from the group consisting of 4-aminostyrene, di-C₁-C₄-alkyl-aminostyrene, styrene, acrylic acid, C₁-C₄-alkylacrylic acid, acrylic or C₁-C₄-alkylacrylamides, acrylic or C₁-C₄alkylacrylmono- or -di-C₁-C₄-alkylamides, acrylic or C₁-C₄-alkylacryl-di-C₁-C₄-alkyl-amino-C₂-C₄-alkylamides, acrylic or C₁-C₄-alkylacryl-amino-C₂-C₄alkylamides, anhydrides orate salts of acrylic acid or C₁-C₄-alkylacrylic acid, acrylic or C₁-C₄-alkylacrylic acid-mono- or -di-C₁-C₄-alkyl-amino-C₂-C₄-alkyl esters, acrylic or C₁-C₄-alkylacrylic acid-hydroxy-C₂-C₄-alkyl esters, acrylic or C₁-C₄-alkylacrylic acid-(C₁-C₄-alkyl)₃silyloxy-C₂-C₄-alkyl esters, acrylic or C₁-C₄-alkylacrylic acid-(C₁-C₄-alkyl)₃silyl-C₂-C₄-alkyl esters, acrylic or C₁-C₄-alkylacrylic acid-heterocyclyl-C₂-C₄-alkyl esters, C₁-C₂₄-alkoxylated poly-C₂-C₄-alkylene glycol acrylic or C₁-C₄-alkylacrylic acid esters, acrylic acid-C₁-C₂₄-alkyl esters and C₁-C₄-alkylacrylic acid-C₁-C₂₄-alkyl esters.

9. A modified halogenated polymer surface obtained in the method according to claim 1.

10. The modified halogenated polymer surface according to claim 9, which corresponds to the formula
(1) HalPol-[In-Aₓ-B_{y}C_{z}-Z]ₙ, wherein
A, B, C represent monomer- oligomer or polymer fragments, which can be arranged in block or statstically;
Z is halogen which is positioned at the end of each polymer brush as end group derived from ATRP:
HalPol represents the halogenated polymer substrate;
In represents the fragment of a polymerization initiator capable of initiating polymerization of ethylenically unsaturated monomers in the presence of a catalyst which activates controlled radical polymerization;
x represents a numeral greater than one and defines the number of repeating units in A;
y represents zero or a numeral greater than zero and defines the number of monomer, oligopolymer or polymer repeating units in B;
z represents zero or a numeral greater than zero and defines the number of monomer, oligopolymer or polymer repeating units in C; and
n is one or a numeral greater than one which defines the number of groups of the partial formula (1a) In-(Aₓ-B_{y}C_{z}-X)—.

11. (canceled)
